(19) United States
(12) Patent Application Publication
(10) Pub. No.: US 2026/0011763 A1
(43) Pub. Date: Jan. 8, 2026

(54) INTEGRATED FUEL CELL SYSTEM INCLUDING INDEPENDENTLY CONTROLLABLE COLUMNS

(71) Applicant: Bloom Energy Corporation, San Jose, CA (US)

(72) Inventors: Prasad PMSVVSV, Sunnyvale, CA (US); Samuel JUDAY, Santa Clara, CA (US); Ranganathan GURUNATHAN, Bangalore (IN); Carl COTTULI, Franklin, MA (US); Michael PETRUCHA, Santa Clara, CA (US); K.R. SRIDHAR, Los Gatos, CA (US); Razvan PANATI, San Jose, CA (US); Deepak SHUKLA, Sunnyvale, CA (US); Yongsheng YANG, Fremont, CA (US); Kishore SHAKALYA, San Jose, CA (US); Joseph TAVI, Danville, CA (US)

(21) Appl. No.: 19/259,371

(22) Filed: Jul. 3, 2025

(30) Foreign Application Priority Data
Jul. 5, 2024 (IN) 202441051575

(51) Int. Cl. H01M 8/1231; B60L 53/53; B60L 53/54; H01M 8/04082; H01M 8/04302; H01M 8/04303; H01M 8/12; H01M 8/2425; H02B 1/56; H02J 3/38

(52) U.S. Cl. CPC H01M 8/1231; B60L 53/53; B60L 53/54; H01M 8/04201; H01M 8/04302; H01M 8/04303; H01M 8/2425; H02B 1/565; H02J 3/381; H01M 2008/1293

(57) ABSTRACT

A system includes a plurality of columns of fuel cells located in a hotbox, a direct current (DC) bus, a plurality of DC/DC converters, each DC/DC converter being electrically connected to a respective column of fuel cells and to the DC bus, and a controller configured for independently controlling the columns of fuel cells. The controller is configured to activate a first column of fuel cells by activating fuel flow to the first column of fuel cells and activating a first DC/DC converter of the plurality of DC/DC converters electrically connected to the first column of fuel cells while a second column of fuel cells is already active.

### TECHNICAL FIELD

The present disclosure generally relates to fuel cell systems, and more particularly, to integrated fuel cell systems including independently controllable columns of fuel cells.

### BACKGROUND

In a fuel cell system, such as a solid oxide fuel cell (SOFC) system, an oxidizing flow is directed to the cathode side of the fuel cell while a fuel or reactant flow is directed to the anode side of the fuel cell. The oxidizing flow is typically air, while the fuel flow can be a hydrocarbon fuel, such as methane, natural gas, pentane, ethanol, or methanol, or a pure hydrogen fuel or an ammonia fuel, or mixtures thereof. During SOFC operation, negatively charged oxygen ions are transported from the cathode flow stream to the anode flow stream, where the ions combine with either free hydrogen or hydrogen in a hydrocarbon molecule to form water vapor, and/or with carbon monoxide to form carbon dioxide. The excess electrons from the negatively charged ions are routed back to the cathode side of the fuel cell through an electrical circuit completed between anode and cathode, resulting in an electrical current flow through the circuit.

### SUMMARY

According to various embodiments, a system includes a plurality of columns of fuel cells located in a hotbox, a direct current (DC) bus, a plurality of DC/DC converters, each DC/DC converter being electrically connected to a respective column of fuel cells and to the DC bus, and a controller configured for independently controlling the columns of fuel cells. The controller is configured to activate a first column of fuel cells by activating fuel flow to the first column of fuel cells and activating a first DC/DC converter of the plurality of DC/DC converters electrically connected to the first column of fuel cells. The controller is configured to activate a first column of fuel cells by activating fuel flow to the first column of fuel cells and activating a first DC/DC converter of the plurality of DC/DC converters electrically connected to the first column of fuel cells while a second column of fuel cells is already active. In addition, in one embodiment, the controller is configured to independently deactivate the first and/or second columns of fuel cells by deactivating fuel flow to the first and/or second columns of fuel cells and deactivating the first and/or second DC/DC converters of the plurality of DC/DC converters electrically connected to the respective first or second columns of fuel cells.

According to various embodiments, a system comprises a DC bus, columns of fuel cells electrically connected to the DC bus, a battery electrically connected to the DC bus, an inverter electrically connected to the DC bus and configured to provide an alternating current (AC) output to a load on an AC circuit, and a start-up rectifier electrically connected to the AC circuit and the DC bus. The start-up rectifier is configured for supplying power from the AC circuit to one or more columns of fuel cells for starting power generation by one or more columns of fuel cells. The start-up rectifier is configured for charging the battery using power from the AC circuit.

According to various embodiments, a system includes a first enclosure having a first section and a second section; a fuel cell component comprising a hotbox containing a plurality of columns of fuel cells and balance of plant components installed in the first section; a power conditioning system installed in the second section; and a ventilation system configured for maintaining a positive air pressure in the second section.

### BRIEF DESCRIPTION OF THE DRAWINGS

The accompanying drawings, which are incorporated herein and constitute part of this specification, illustrate examples of the disclosed devices and methods, and together with the general description given above and the detailed description given below, serve to explain the features of the invention.

FIGS. 1A-1E are different views of cabinets of an integrated fuel cell system, according to an embodiment of the present disclosure. FIG. 1A is a perspective view, FIG. 1B is a front view, FIG. 1C is a back view, FIG. 1D is a top view and FIG. 1E is a side view.

FIG. 2 is a block diagram of an electrical circuit of the integrated fuel cell system electrically connected to different loads, according to an embodiment of the present disclosure.

FIGS. 3A-3D are schematic block diagrams that illustrate operating modes of the integrated fuel cell system of FIG. 2, according to embodiments of the present disclosure.

FIG. 4 is a block diagram of the electrical circuit of the integrated fuel cell system electrically connected to different loads and to additional power sources, according to an embodiment of the present disclosure.

FIGS. 5A-5B are schematic block diagrams that illustrate bypass modes using an automatic transfer switch (ATS) during interruptions of power provided from the integrated fuel cell system of FIG. 4, according to embodiments of the present disclosure.

FIGS. 6A-6D are schematic block diagrams that illustrate steps in methods of starting the integrated fuel cell system of FIG. 4, according to embodiments of the present disclosure.

FIGS. 7A-7E illustrate example mechanical features of the cabinets of the integrated fuel cell system shown in FIGS. 1A-1E, according to embodiments of the present disclosure.

FIGS. 7A and 7E are front views, FIGS. 7B-7C are perspective cut-away views and FIG. 7D is a block diagram of the mechanical features.

FIG. 8 is a partially transparent perspective view of an interior of a fuel cell section of the cabinet having dual ventilation fans according to an embodiment of the present disclosure.

FIGS. 9A-9B are perspective views of components of the integrated fuel cell system that can be replaced when the integrated fuel cell system is operating, according to embodiments of the present disclosure.

FIGS. 10A-10C are perspective views of electrical and fluid interconnections for the integrated fuel cell system, according to embodiments of the present disclosure.

FIGS. 11A-11F are schematic block diagrams of electrical system components of the integrated fuel cell system that provide independent fuel cell column control, according to embodiments of the present disclosure.

FIGS. 12A-12D are schematic block diagrams of optional components of the power conditioning system (PCS) of the integrated fuel cell system, according to embodiments of the present disclosure.

### DETAILED DESCRIPTION

The various examples will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims. It is also understood that the examples shown in the figures are not mutually exclusive. Features shown in one example (e.g., in one figure) may be included in other examples (e.g., in other figures).

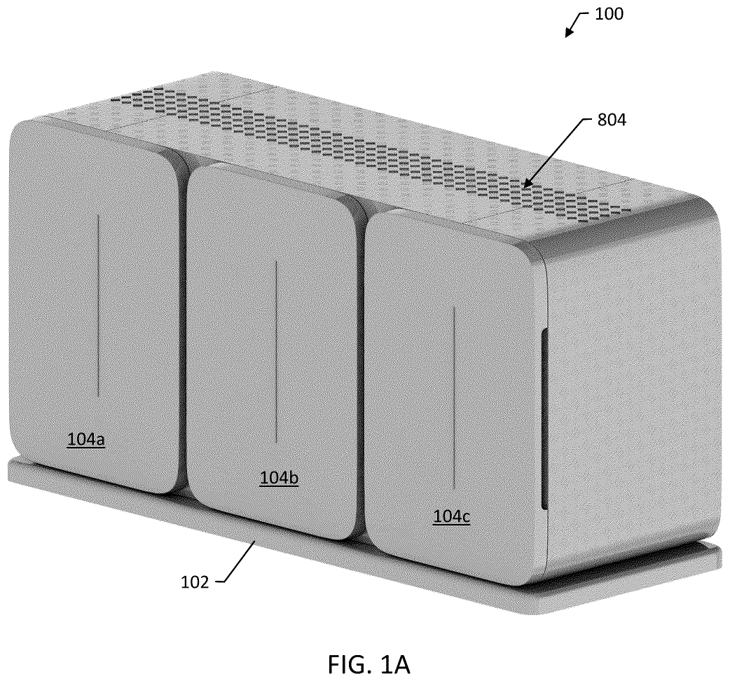

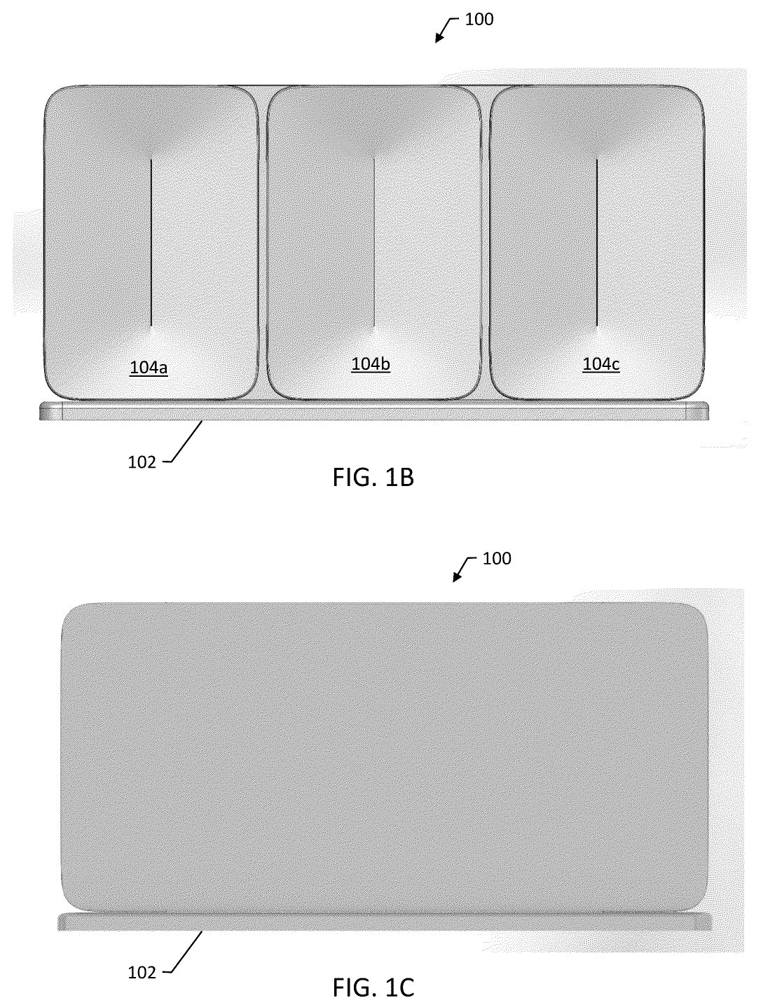

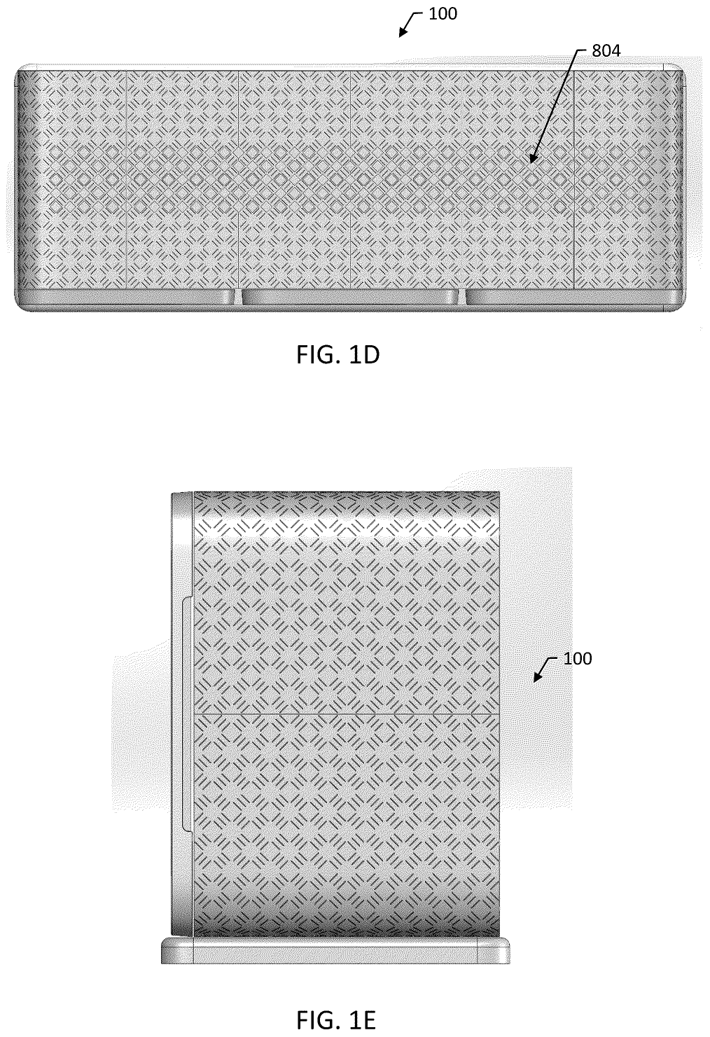

FIGS. 1A-1E are different views of cabinets of an integrated fuel cell system 100, according to an embodiment of the present disclosure. FIG. 1A is a perspective view of the system 100. FIG. 1B is a front view of the system 100. FIG. 1C is a rear view of the system 100. FIG. 1D is a top view of the system 100. FIG. 1E is a right side view of the system 100. The left side view (not shown) is a mirrored image of the right side view.

The system 100 includes a hot box enclosing two or more fuel cell columns, at least one supporting battery, balance of plant (BOP) components, and power conditioning system (PCS) electronics. The system components can be integrated into a single shippable product in one or more cabinets. The system 100 can be configured for independently powering a residence (e.g., a home, such as a detached house, a town house (e.g., row house) or a multi-family dwelling) or other suitable electrical system or load. For example, the system 100 can be used for allowing a residence to be off-grid, e.g., the residence can be powered without reliance on a utility electrical grid for electrical power. The system 100 can operate using any suitable fuel source, for example, a hydrocarbon fuel (such as natural gas, etc.), hydrogen, or a hydrogen-natural gas blend.

The system 100 includes a base 102 and three cabinets (104a, 104b and 104c) mounted on the base 102. Each of the three cabinets 104a-104c comprises a portion of the at least one cabinet (e.g., two cabinets to be described below) that houses one or more components of the system 100. For example, the first cabinet 104a can house the battery, the second cabinet 104b can house the power and fluid conditioning systems, and the third cabinet 104c can house the hot box containing two or more fuel cell columns. One or more exhaust ports 804 are located on top of at least cabinet 104c, and in some embodiments on top of at least two of cabinets, such as on top of all three cabinets 104a-104c.

In one embodiment, the base 102 may comprise a concrete or metal base containing channels for electrical wiring and fluid conduits (e.g., pipes), as described in U.S. Pat. Nos. 8,822,101 B2 and 9,755,263 B2, incorporated by reference in their entirety. Alternatively, the base 102 may comprise an elevated metal skid containing at least one channel for electrical wiring and fluid conduits (e.g., pipes), as described in U.S. Patent Application Publication Number US 2023/0282867 A1, incorporated by reference in its entirety. The cabinets 104a-104c may comprise metal cabinets, as will be described in more detail below.

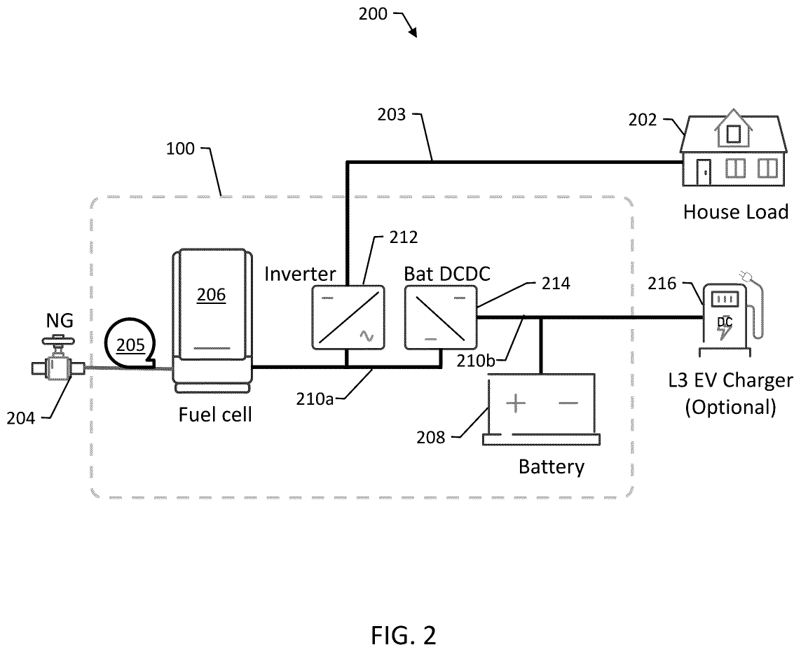

FIG. 2 is a block diagram of an electrical circuit 200 of the integrated fuel cell system 100 electrically connected to different electrical loads 202, 216, according to an embodiment of the present disclosure. The system 100 provides power to an alternating current (AC) electrical load, such as a residential load 202 (e.g., a home, such as a detached residential load, a town house (e.g., row house) load, or a multi-family dwelling load) or another suitable AC load via an AC bus 203 and optionally to a direct current (DC) electrical load 216 (such as an electric vehicle (EV) charger) via segments 210a, 210b of a common DC bus. The two or more of the fuel cell columns of the system draw fuel from a fuel source 204, such as natural gas connection to a natural gas pipeline, or to fuel storage vessel, such as a hydrocarbon or hydrogen fuel tank.

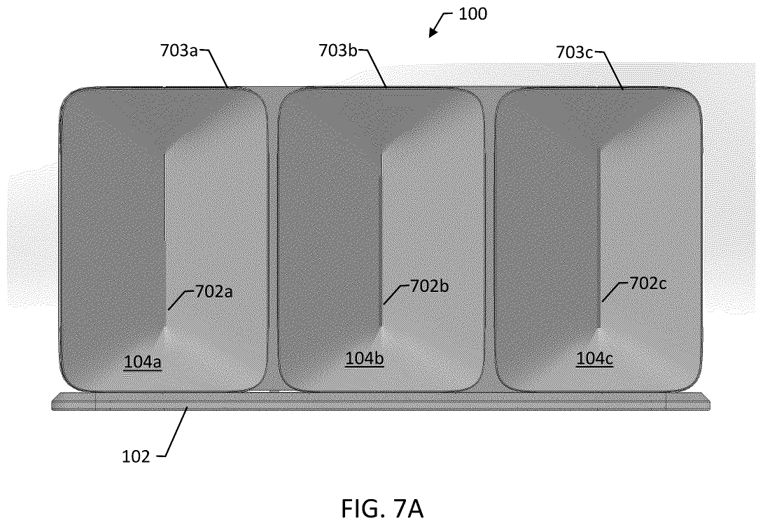

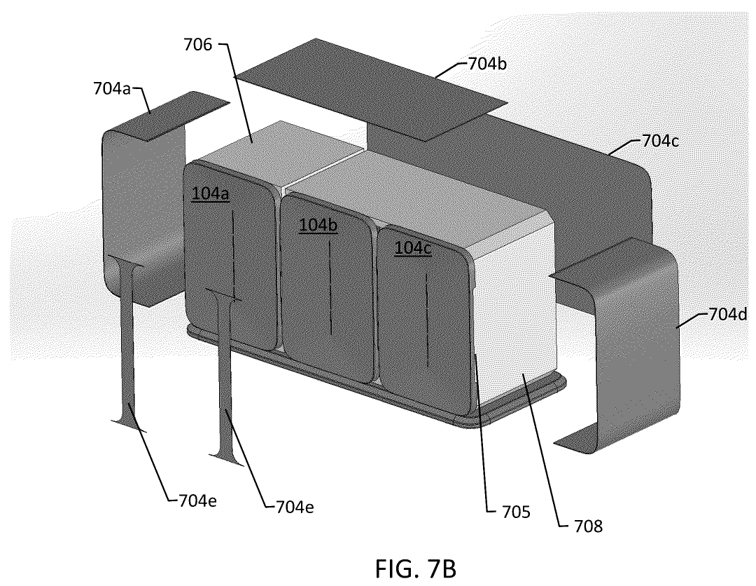

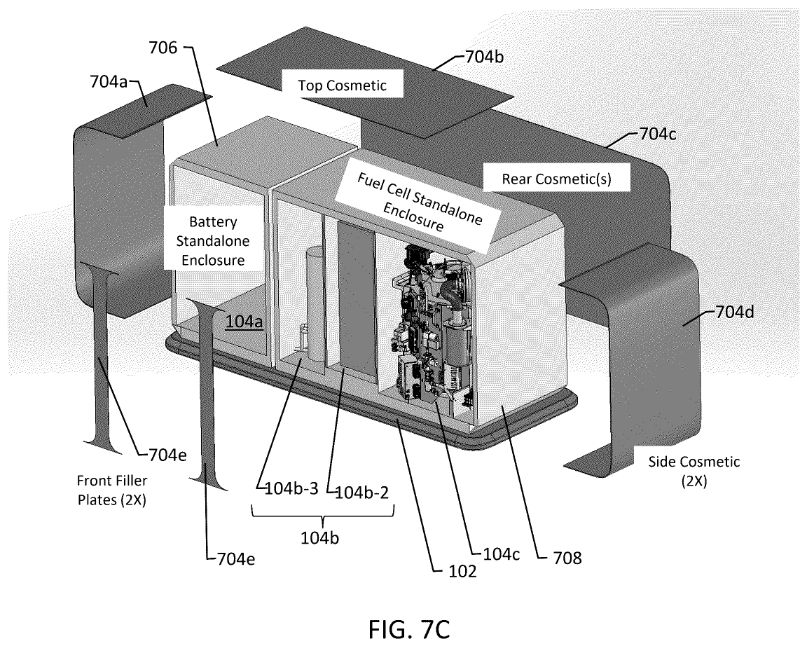

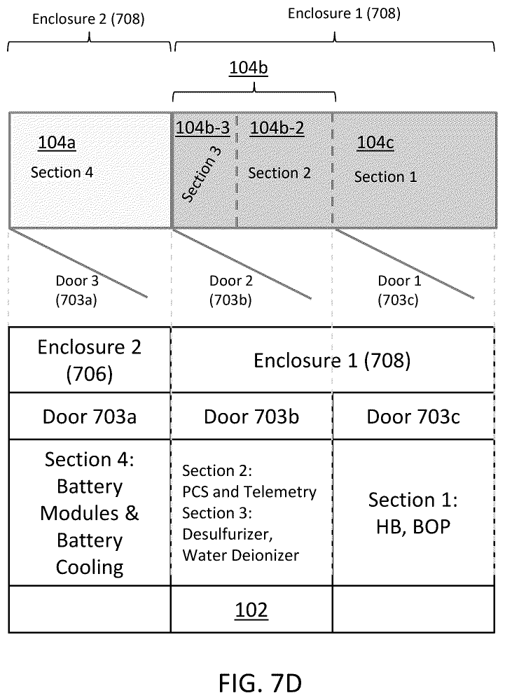

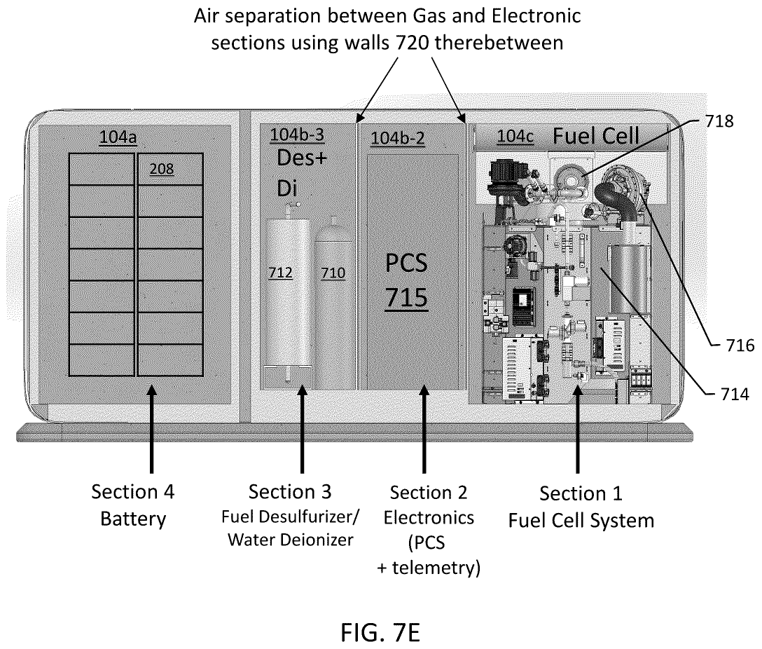

The system 100 includes a fuel cell component 206 including a plurality of fuel cell columns and balance of plant (BOP) components configured to generate electric power using the above described electrochemical reaction. Each column may include one or more fuel cell stacks. For example, the system 100 can include columns of solid oxide fuel cells which are alternated with conductive interconnects in the columns. The fuel cell component 206 may comprise components located in cabinet 104c shown in FIGS. 1A and 7C. An optional booster blower 205 may be located on the conduit connecting the fuel source 204, such as a natural gas pipeline, to the fuel cell component 206. If the fuel supply, such as a natural gas supply, from the fuel source 204 is lower than the specification (e.g., designed natural gas operating pressure or flow rate) of the fuel cell component 206, then the booster blower 205 may be operated to increase the fuel (e.g., natural gas) pressure or flow rate to the desired level to meet the specification of the fuel cell component 206. In one embodiment, the booster blower 205 may be powered by DC electric power supplied from the DC bus 210a and/or 210b.

The system 100 also includes a supporting battery 208 configured to provide electrical power (e.g., DC power), for example, supplementary power during peak demand or transient conditions. The system 100 also includes a first common direct current (DC) bus segment 210a that serves as a central node for DC power distribution within the system 100 and from the system to any DC load 216. A DC/AC inverter 212, which converts DC power to alternating current (AC) power suitable for use by the residential load 202 has an input electrically connected to the first DC bus segment 210a and an output connected to the AC bus 203.

The battery 208 is electrically connected to a battery DC/DC converter 214 via a second segment of the DC bus 210b. The battery DC/DC converter 214 regulates the voltage and current from the battery 208 for compatibility with one or both of the DC bus segments 210a and/or 210b. The residential load 202 is connected to the AC bus 203 which is connected to the output of the main inverter 212, allowing for the provision of AC power to various residential systems (e.g., lighting system, etc.) and appliances. The battery 208 is electrically connected to the main inverter 212 through the both DC bus segments 210a, 210b and the battery DC/DC converter 214.

The battery 208 may have any appropriate battery chemistry. For example, lithium-ion batteries can be used for their high energy density, long cycle life, and relatively low self-discharge rate. Alternatively, nickel-metal hydride (NiMH) batteries may be employed, offering a good balance of energy density and safety, along with a tolerance to overcharging. Lead-acid batteries, although heavier and having a lower energy density, provide a cost-effective solution with a proven track record in backup power applications. Other battery chemistries, such as lithium iron phosphate (LiFePO₄) provide enhanced thermal stability and safety features, making them suitable for high-temperature environments. Solid-state batteries may offer higher energy densities and improved safety profiles by eliminating liquid electrolytes.

The battery 208 may be replaced with or supplemented by other energy storage devices, such as supercapacitors or flywheel energy storage systems. Similarly, the main inverter 212 may comprise multiple inverters to manage different sections of the residential load 202 or to provide redundancy in critical applications.

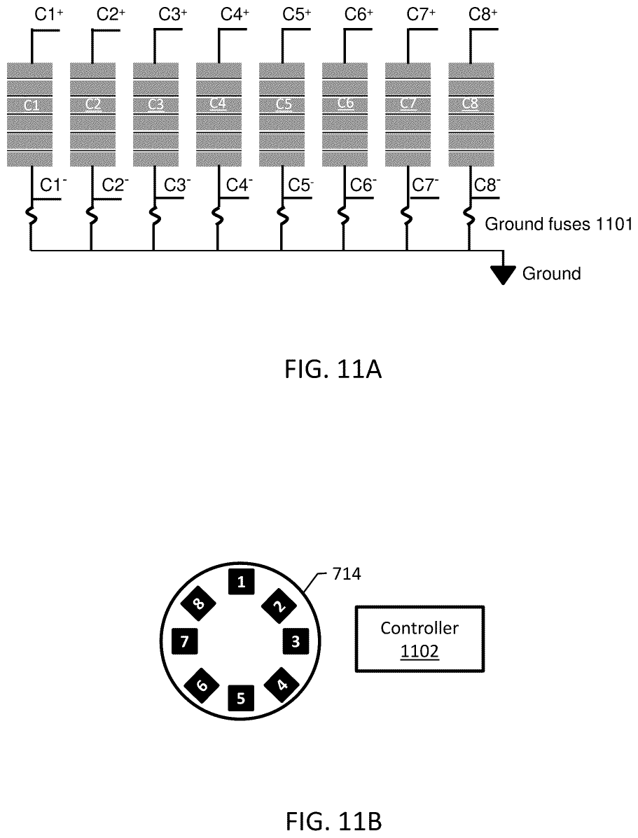

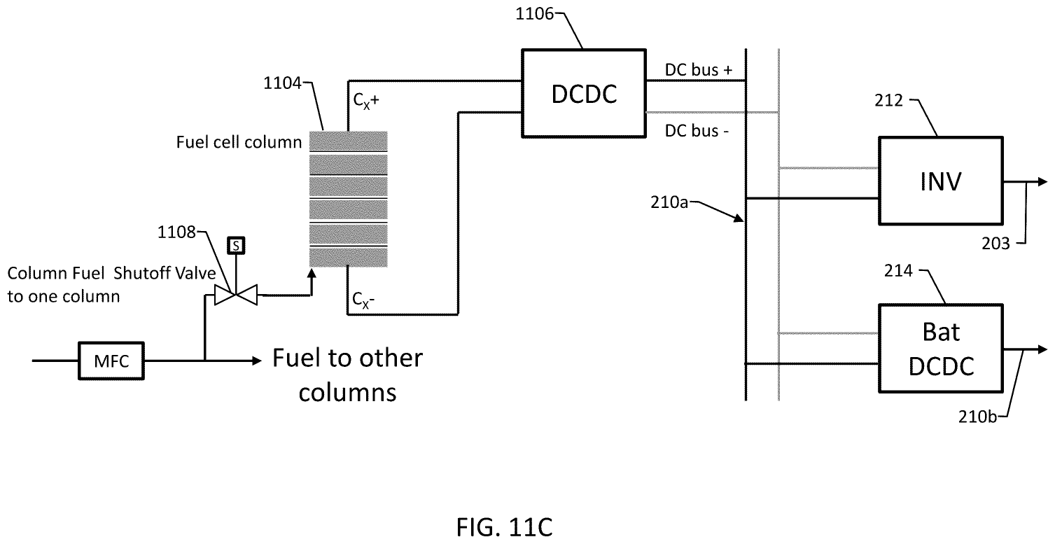

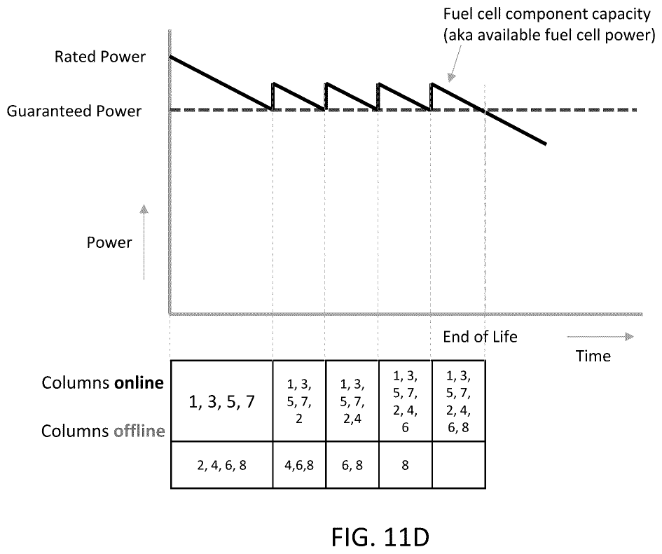

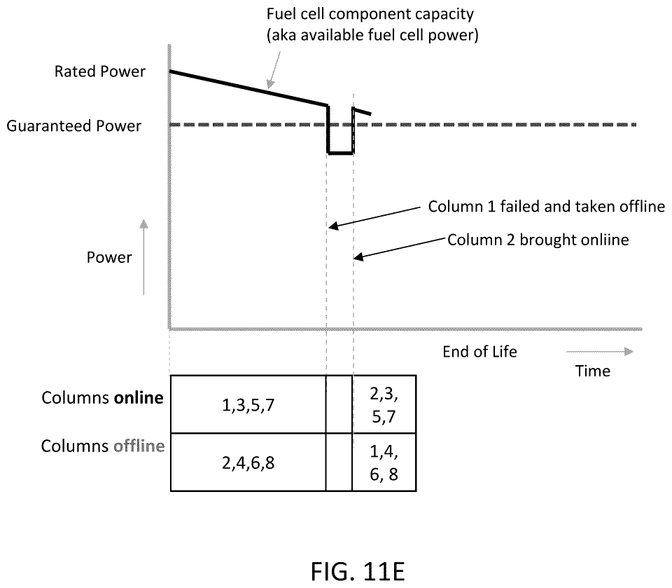

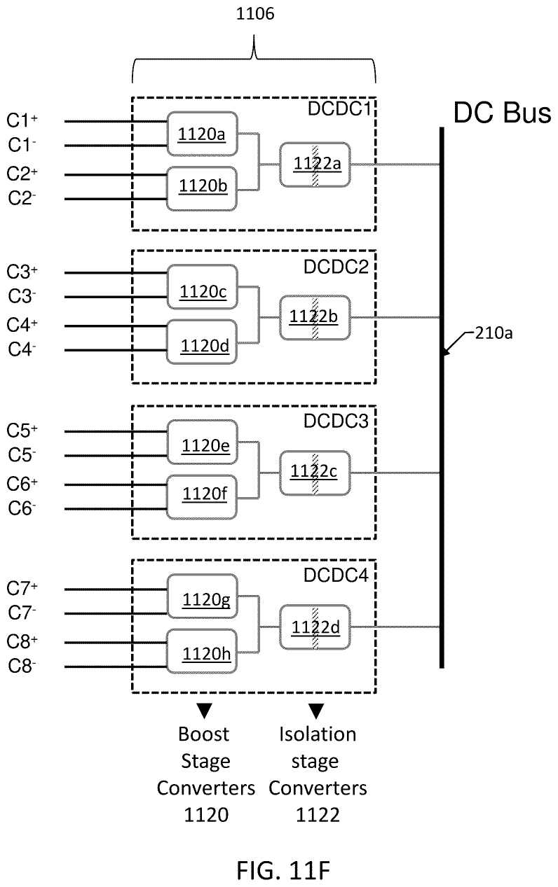

A battery DC/DC converter 214 is connected to both DC bus segments 210a, 210b. The input of the battery DC/DC converter 214 may be connected to one segment of the DC bus (e.g., the first segment 210a) and the output of the battery DC/DC converter 214 may be connected to the other segment of the DC bus (e.g., the second segment 210b), such that the DC bus passes through the battery DC/DC converter 214. While FIG. 2 schematically illustrates one DC bus with two segments passing through the battery DC/DC converter 214, physically the first and second segments 210a, 210b comprise different DC power busses which may carry different DC voltages and/or power levels. In one embodiment, the fuel cell component 206 may include an additional fuel cell DC/DC converter 1106 (shown in FIG. 11C) for controlling the DC current and voltage output by the fuel cell columns to the first segment of the DC bus 210a.

In some embodiments, the circuit 200 also includes a DC load, such as an electric vehicle (EV) charger 216 (e.g., a level 3 DC input charger) electrically connected to the second DC bus segment 210b of the system 100. The EV charger 216 can be coupled to the battery DC/DC converter 214 through the second segment of the DC bus 210b. The battery 208 and the battery DC/DC converter 214 are responsible for efficient regulation of voltage and current supplied to the EV charger 216. This configuration permits the fuel cell component 206 and/or the battery 208 to directly supply power to the EV charger 216, which can be useful for, among other things, optimizing the charging process and reducing conversion losses. The EV charger 216 can be positioned adjacent to the system 100, facilitating a compact and integrated setup that minimizes wiring complexity and installation costs. Alternatively, the EV charger 216 can be located in a separate area, such as near the EV parking area, to provide convenient access for vehicle charging, or in a garage of the residential (e.g., house) load 202. This remote positioning can be achieved by extending power lines from the system 100 to the designated charging location, ensuring that the EV charger 216 remains connected to the overall electrical architecture 200. The placement and integration of the EV charger 216 can be customized based on spatial constraints, user preferences, and specific use case scenarios, ensuring flexible and efficient deployment within residential, commercial, or industrial environments.

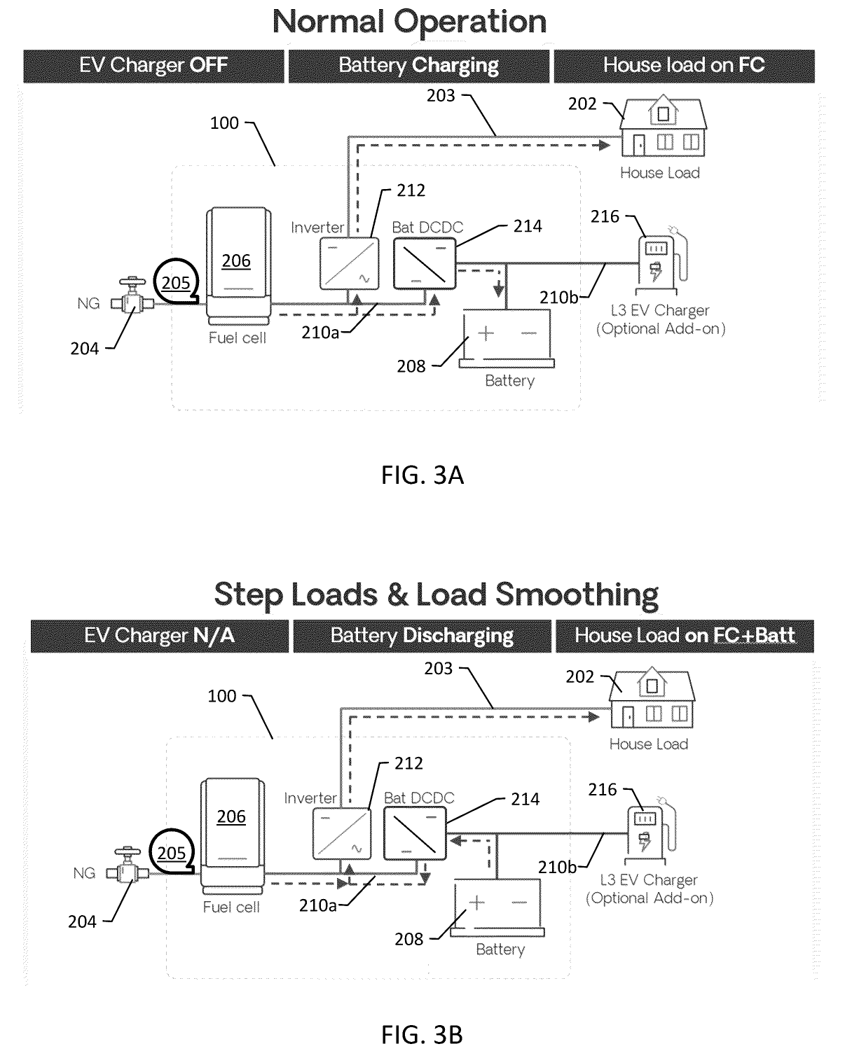

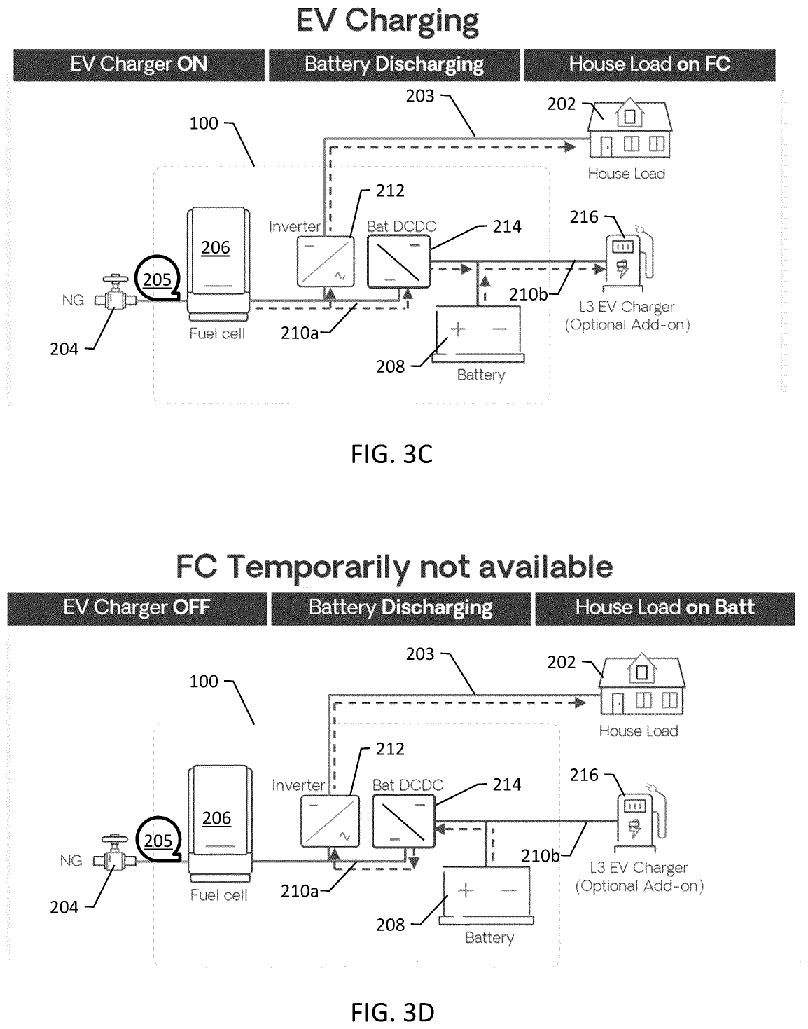

FIGS. 3A-3D are schematic block diagrams that illustrate operating modes of the integrated fuel cell system 100 of FIG. 2, according to embodiments of the present disclosure.

FIG. 3A illustrates a normal (i.e., steady state) operation mode of the system 100. In this mode, the fuel cell columns of fuel cell component 206 produce power at their designed power output capacity (e.g., up to their rated capacity) and provide the power (i.e., current) to the residential load 202 through the main inverter 212 and the AC bus 203, and any residual power to the battery 208 through the battery DC/DC converter 214 and the second DC bus segment 210b. The residential load 202 is given first priority, and any surplus power, which equals to the difference between fuel cell column power generation (i.e., output power of the fuel cell component 206) and residential load demand, is directed to the battery 208. Charging of the battery 208 ceases once it reaches the desired charge level, and thereafter, the fuel cell column power generation output is adjusted (e.g., by controlling the fuel cell DC/DC converter 1106 and/or the amount of fuel provided from the fuel source 204, or the amount of fuel provided to each column) to follow the residential load demand. In one embodiment, the EV charger 216 is off during the normal operation mode.

FIG. 3B illustrates a step load and load smoothing mode. In instances where the residential load 202 demand exceeds the fuel cell column generated power (i.e., output power of the fuel cell component 206), the battery 208 compensates for the power deficit through the battery DC/DC converter 214. The residential load demand may exceed the generated power due to an unexpected surge in the residential load demand or a partial reduction in fuel cell component 206 output power due to a failure, a transition mode and/or an interruption in the supply of fuel. In this embodiment, the battery 208 outputs DC current on the second DC bus segment 210b. The DC current is provided from the second DC bus segment 210b through the battery DC/DC converter 214, the first DC bus segment 210b, the inverter 212 and the AC bus 203 to the residential load 202 in addition to or instead of the DC current from the fuel cell component. Once the fuel cell component 206 recovers from the deficit, i.e., when the fuel cell column power generation slightly surpasses the residential load demand, or when the residential load demand drops, the normal operating mode resumes and the battery 208 resumes charging if excess power is available from the fuel cell component 206.

In some cases, fuel cell columns are unable to ramp up as quickly as the residential load 202 demand increases. In these cases, the battery 208 can provide support during such step-up load demands. The battery acts as a buffer until the fuel cell component can match the load power demand to the new load level. During step-down loads, i.e., load decreases, the fuel cell component can typically follow the load demand without requiring battery assistance (i.e., without relying on power output of the battery 208).

FIG. 3C illustrates an EV charging mode. In some cases, the high-power EV charger 216 demands significantly more power than the fuel cell component's power rating. For example, the fuel cell system 100 may be rated for 20 KW, while the EV charger 216 is rated at 120 kW. In this case, the battery 208 supplies the balance of power to the EV charger 216. The residential load 202 continues to take precedence, and the power balance equation is as follows:

$$Power delivered to EV charger = Available power from battery + Available power from fuel cell component - Residential load$$

The power directed to the EV charger 216 may vary based on the residential load, instantaneous fuel cell component 206 power generation, and the available power from the battery 208 at that moment. In this mode, the fuel cell columns of the fuel cell component 206 provide the power (e.g., AC) to the residential load 202 through the main inverter 212 and the AC bus 203, and any residual power (e.g., DC) to the EV charger 216 through the first DC bus segment 210a, the battery DC/DC converter 214 and the second DC bus segment 210b. The battery 208 satisfies the remaining load demand from the EV charger 216 by supplying DC current to the EV charger 216 through the second DC bus segment 210b.

FIG. 3D illustrates an offline mode in which the fuel cell component 206 power is temporarily not available, such as due to a complete loss of power output from the fuel cell component 206 (e.g., due to an interruption in fuel or component failure or servicing). In this mode, power delivery to the EV charger 216 may be entirely disabled to preserve the energy stored in the battery 208 for satisfying the residential load 202 demand. However, in some embodiments, system 100 users have the option to override this mode through a mobile app, prioritizing supplying power to the EV charger 216 over supplying power to the residential load 202. In this mode, the DC current flows from the battery 208 to the inverter 212 via the second DC bus segment 210b, the battery DC/DC converter 214 and the first DC bus segment 210b. The inverter 212 converts DC to AC. The AC then flows from the inverter 212 to the residential load 202 via the AC bus 203.

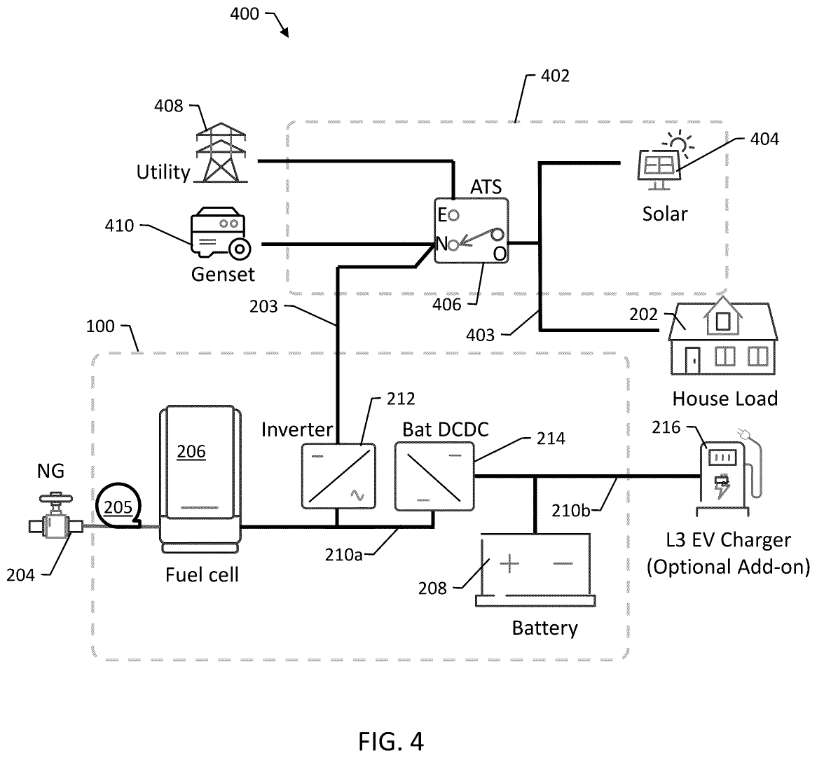

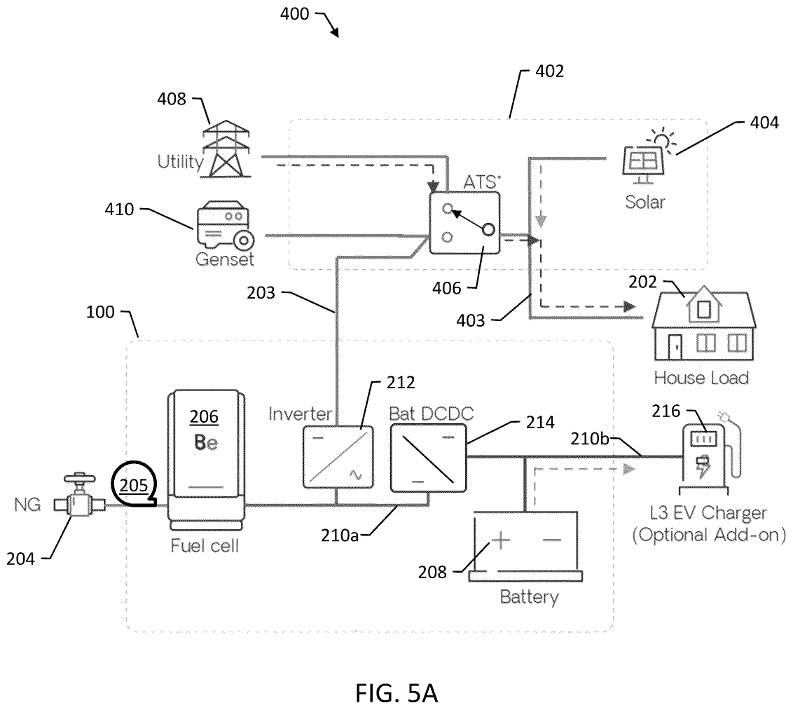

FIG. 4 is a block diagram of the electrical circuit 400 of the integrated fuel cell system 100 electrically connected to different loads 202, 216 and to additional power sources 404, 408 and/or 410, according to an embodiment of the present disclosure. In this embodiment, the fuel cell system 100 is electrically integrated with other onsite equipment 402, which may comprise equipment that is pre-existing or installed together with the fuel cell system 100. The onsite equipment 402 can include, for example, a solar power system 404 and/or an automatic transfer switch (ATS) 406 coupled to at least one AC power source, such as an electric utility grid 408 and/or a generator 410 (such as a diesel generator or other suitable generator). The grid 408 may be electrically connected to the emergency node “E” of the ATS 406, while the generator 410 and the fuel cell component 206 may be electrically connected to the normal node “N” of the ATS 406 and the residential load 202 is electrically connected to the output node “O” of the ATS 406 via respective AC electrical buses. The solar power system 404 may be installed on the roof of the residence (i.e., the residential load 202) or another suitable location. The solar power system 404 may include a dedicated DC/AC inverter (not shown) and may be connected to the residential load 202 via a separate AC electrical bus and/or through the same AC electrical bus 403 that is connected to the output node of the ATS 406.

The ATS 406 can be utilized in conjunction with the fuel cell system 100 to use utility power from the grid 408 as a backup. The ATS 406 may be an existing unit, e.g., currently used by the residence or may be installed together with the fuel cell system 100. The ATS 406 may alternate the power supply to the residential load 202 between the utility 408 power and alternative power, such as power from the fuel cell system 100 and/or power from the generator 410.

In general, the ATS 406 can be implemented using any appropriate technology. For example, electromechanical transfer switches can be used for their reliability and straightforward operation, employing mechanical relays or contactors to physically change the electrical connection between power sources. Alternatively, solid-state transfer switches utilize semiconductor devices such as thyristors or transistors to achieve faster switching times and reduce electrical arcing, enhancing the durability and performance of the system.

Hybrid transfer switches combine both electromechanical and solid-state components to leverage the advantages of both technologies, providing rapid switching capabilities while maintaining the robustness of mechanical contacts. Microprocessor-based ATS systems can offer advanced features such as real-time monitoring, diagnostics, and remote control, enabling more efficient and intelligent management of power sources. The selection of the ATS technology can be based on factors such as load requirements, response time, environmental conditions, and cost considerations, ensuring seamless and reliable transfer of power in various applications.

The generator 410 can be a generator running on any suitable fuel, such as diesel, propane, or natural gas. The generator 410 can be incorporated as an additional redundant power source which can serve as a supplement to or a substitute for utility power. The generator 410 may comprise a preexisting generator located at the residence before the installation of the fuel cell system 100, or may be installed together with or after the fuel cell system 100 for an extra degree of power supply redundancy and security. Alternatively, the generator 410 may be omitted.

The solar power system 404 may be installed at the residence before, together with or after the fuel cell system 100. Any appropriate type of solar power system 404 can be used. For example, the solar power system 404 may comprise a photovoltaic system including photovoltaic panels which directly convert sunlight into electrical energy using any suitable semiconductor materials, such as silicon or compound semiconductor materials. Monocrystalline silicon panels offer high efficiency and long lifespan, making them a popular choice for residential installations. Alternatively, polycrystalline silicon panels provide a cost-effective option with slightly lower efficiency. Solar cells containing quantum dots or perovskite materials may be utilized in the solar panels. Thin-film solar panels, made from materials such as cadmium telluride (CdTe), copper indium gallium selenide (CIGS) or amorphous silicon, offer flexibility and lightweight properties, allowing for versatile installation on various surfaces. Alternatively, the solar power system 404 may comprise a concentrated solar power (CSP) system, which uses mirrors or lenses to concentrate sunlight onto a small area to produce heat and generate electricity, depending on the spatial and environmental conditions of the installation site. The choice of solar power system 404 can be tailored to the specific energy requirements, budget constraints, and physical characteristics of the customer's property, ensuring optimal integration and performance when combined with the fuel cell system 100.

The circuit 400 can be tailored in various ways based on desired specifications. For example, to incorporate a generator 410 but not utility 408 power, the ATS 406 input connections can be configured with the fuel cell system 100 electrically connected to the normal node N of the ATS 406 and the generator 410 electrically connected to the emergency node E of the ATS 406. In an alternative embodiment, the solar system 404 may be electrically connected to the emergency node E of the ATS 406 together with the utility grid 408. During normal (e.g., steady state) operating mode, the power (e.g., AC) flows from the fuel cell system 100 via the AC bus 203 to the normal node N of the ATS 406, and then from the output node O of the ATS 406 to the residential load 202 via an AC bus 403. The power may also flow from the solar power system 404 to the residential load 202 via the same AC bus 403 or a different AC bus.

In some embodiments, an external battery system can be integrated with the fuel cell system 100 as an additional backup. The interconnection point between such an external battery, the fuel cell system 100, and the residential load 202 can vary depending on site-specific use cases, such as the location of the external battery system and existing connections to the customer's infrastructure.

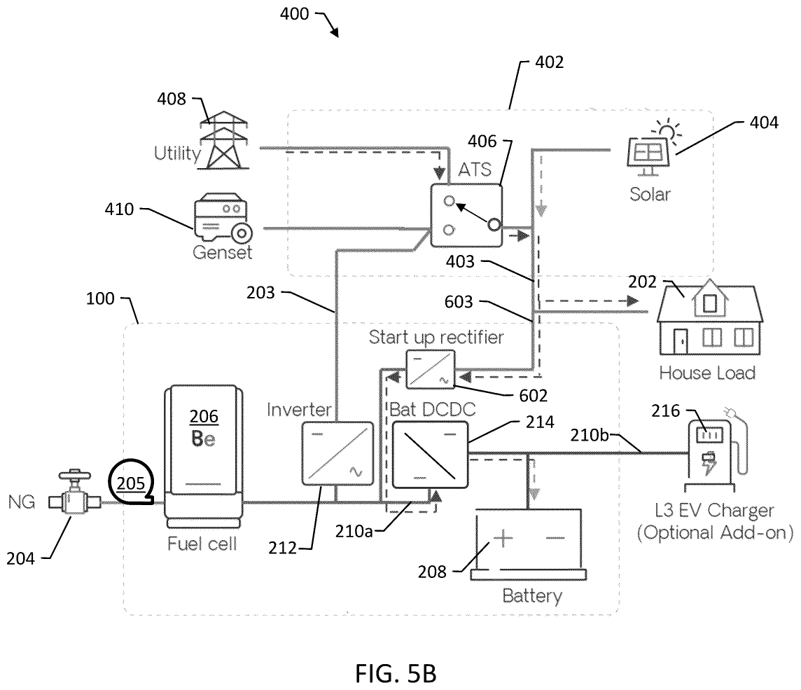

FIGS. 5A-5B are schematic block diagrams that illustrate bypass modes using the ATS 406 during interruptions of power provided from the integrated fuel cell system 100 of FIG. 4, according to embodiments of the present disclosure.

FIG. 5A illustrates a standard bypass configuration through the ATS 406. In the event that the fuel cell system 100 fails to supply power to the residential load 202, the ATS 406 or another circuit 400 component detects the absence of power from the fuel cell system 100. In response, the ATS switches electrical connection of the output node O from the normal node N to the emergency node E. This transfers the residential load 202 to a backup power supply connected to the ATS's emergency node E. Typically, this backup power source is the utility grid 408, but it could also be an alternative source such as a generator 410. While the residential load 202 is drawing power from a backup power supply (e.g., utility grid 408) via the emergency node E of the ATS, the output node O of the ATS and the AC bus 403, the energy stored in the battery 208 may either be utilized for powering the EV charger 216 via the second DC bus segment 210b or reserved for restarting the fuel cell component 206 of the fuel cell system as part of the restart process. If present, the solar power system 404 may also provide power to the residential load 202 during this mode.

FIG. 5B illustrates an alternative bypass configuration through the ATS 406. In this configuration, the AC bus 403 may be electrically connected to the first DC bus segment 210a between the main inverter 212 and the battery DC/DC converter 214 via a start-up AC bus 603 and a start-up rectifier 602 on the start-up AC bus 603. The backup AC power from the output node O of the ATS 406 flows through the AC bus 403 to both the residential load 202 and the start-up AC bus 603. The start-up rectifier 602 converts the AC power to DC power and provides it to the battery 208 of the fuel cell system 100 through the first DC bus segment 210a, the battery DC/DC converter 214 and the second DC bus segment 210b.

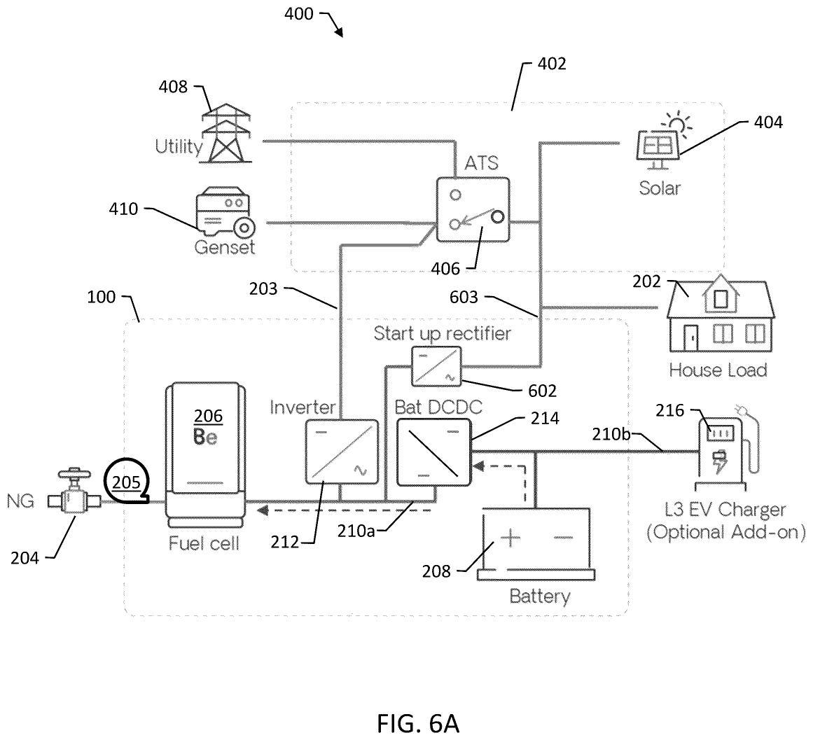

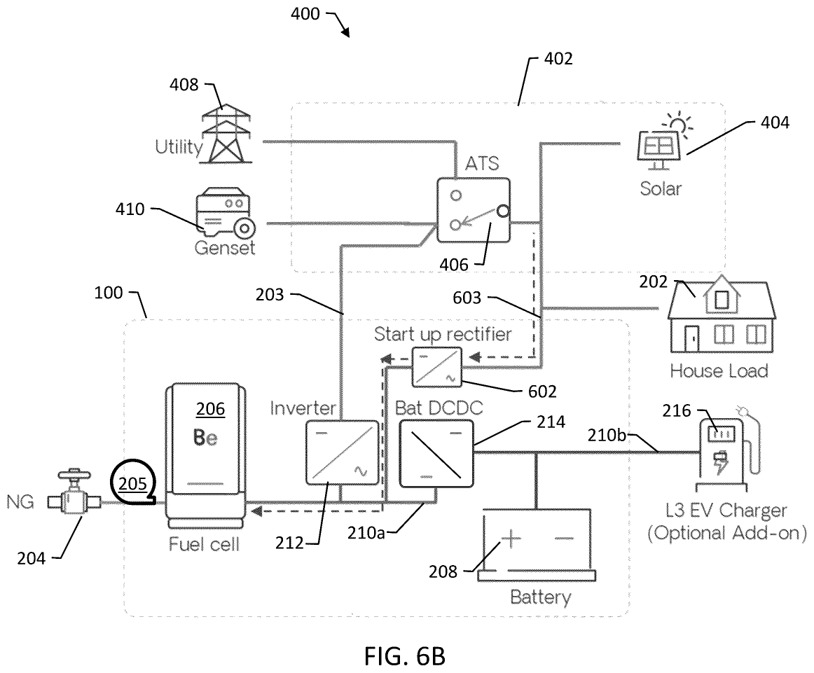

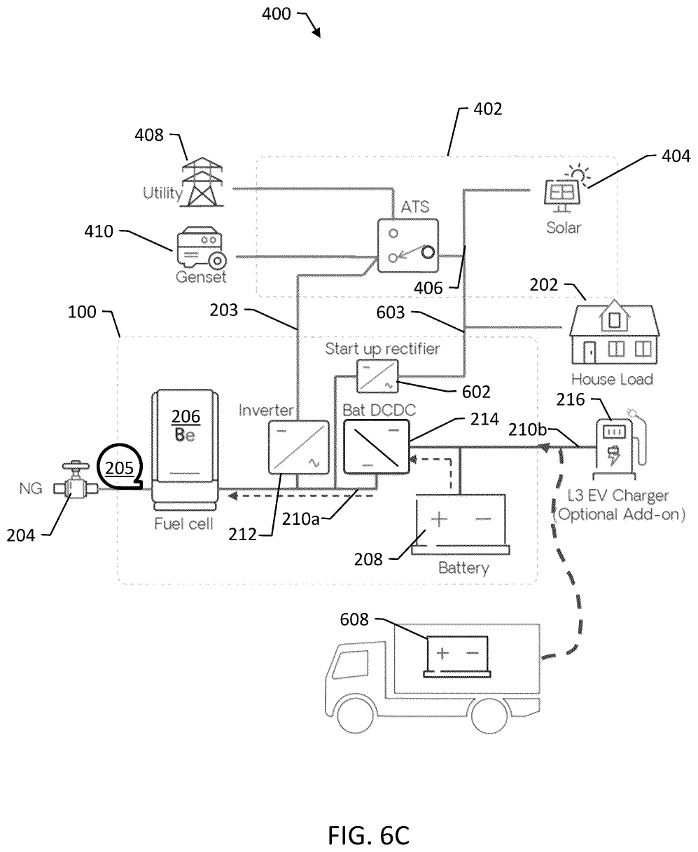

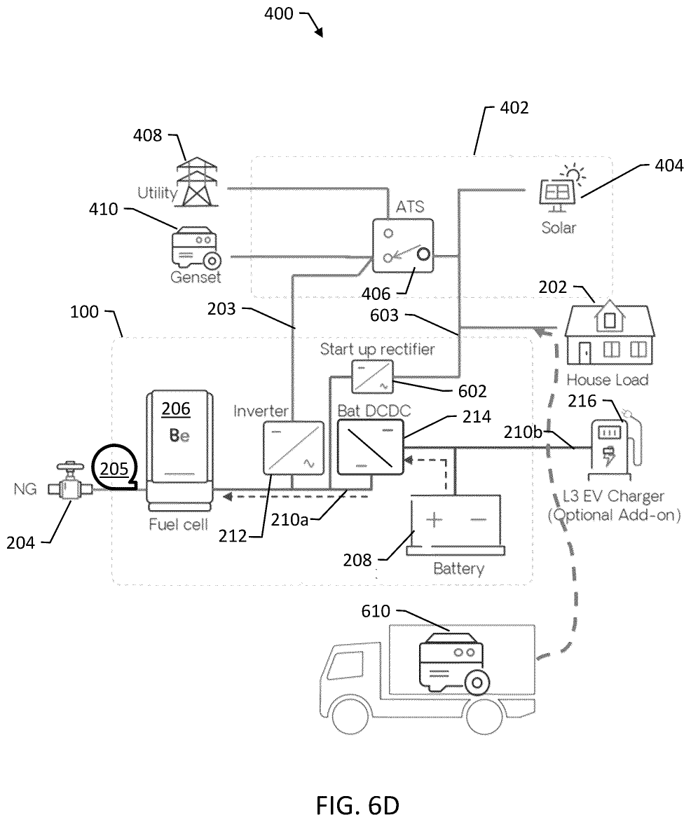

FIGS. 6A-6D are schematic block diagrams that illustrate steps in methods of starting the integrated fuel cell system of FIG. 4, according to embodiments of the present disclosure. A certain amount of power is used to start the fuel cell component 206 from an off state to an on state to generate power. This process, known as a ‘cold start,’ involves powering up the balance of plant (BOP) components (e.g., fuel valve(s), air and fuel recycle blowers, etc.) and heating the fuel cell columns from room temperature to their typical operating temperatures (e.g., at least 700° C., such as 750 to 900° C. for SOFCs) by providing fuel and air to the fuel cells in the columns. The fuel cells generate power and heat up the columns.

FIG. 6A illustrates an embodiment where the start-up power to the BOP components is supplied by the battery 208, provided that sufficient energy is available at the appropriate time. DC power flows from the battery 208 to the fuel cell component 206 through the second DC bus segment 210b, the battery DC/DC converter 214, and the first DC bus segment 210a during the cold start of the fuel cell component 206.

In an alternative embodiment, if the EV charger 216 is equipped with a reverse power option and if an EV is connected to the EV charger 216, then the DC power may be provided from the EV to the fuel cell component 206 in addition to or instead of from the battery 208 through the second DC bus segment 210b, the battery DC/DC converter 214 and the first DC bus segment 210a during the cold start of the fuel cell component 206. Alternatively or in addition, the EV may be used to power the residential load 202. The DC power may be provided from the EV to the residential load 202 in addition to or instead of from the battery 208 through the second DC bus segment 210b, the battery DC/DC converter 214, the first DC bus segment 210a, the inverter 212 (which converts DC power to AC power) and the AC bus 203. In the embodiment of FIG. 6A, the start-up rectifier 602 and the start-up AC bus 603 may be present or omitted.

FIG. 6B illustrates an alternative embodiment where the start-up rectifier 602 supplies the start-up power for fuel cell component 206 of the fuel cell system 100. The start-up rectifier 602 is electrically connected between the first DC bus segment 210a and the start-up AC bus 603 of the residential load AC circuit. Thus, the fuel cell component 206 of the fuel cell system 100 can be started from the AC power source, such as the utility grid 408, the generator 410, or the solar power system 404.

In this embodiment, the AC power source, such as the utility grid 408 or the generator 410 provides AC power to a respective input node (e.g., E or N) of the ATS. The AC power flows from the output node O of the ATS 406 via the AC bus 403 to the residential load AC circuit (e.g. the residential load 202 and the start-up AC bus 603).

The start-up rectifier 602 operates by converting AC from the residential load AC circuit into DC to supply the necessary start-up power to the fuel cell component 206 of the fuel cell system 100. In scenarios where the utility grid 408 provides the AC power, the start-up rectifier 602 ensures seamless integration and reliable start-up performance. If the generator 410 is used as the AC power source, the start-up rectifier 602 accommodates variations in generator 410 output, maintaining consistent start-up conditions for the fuel cell system 100.

The start-up rectifier 602 can be configured to handle the initial power surge during start-up, preventing disruptions to the residential load AC circuit and ensuring a smooth transition to normal operation mode shown in FIG. 4. Once the fuel cell system 100 is fully operational in its steady state mode at its designed operating temperature, the start-up rectifier 602 may disengage or transition to a standby mode, ready to provide start-up energy in future instances as needed. This configuration enhances the reliability and efficiency of the fuel cell system 100, ensuring that it can be rapidly and effectively brought online from various AC sources.

FIG. 6C illustrates an alternative embodiment in which the fuel cell component 206 of the fuel cell system 100 is started using a roll up battery energy storage system (BESS) 608. In this case, an external battery can be transported to the site on a vehicle, such as a truck and connected to the fuel cell system 100. In this example, the external DC power from the roll-up battery is electrically connected to the second DC bus segment 210b at the EV charger's location or through the EV charger 216. In general, the external DC power source can be connected to any appropriate DC electrical node of the system 100.

FIG. 6D illustrates an alternative embodiment in which the fuel cell component 206 of the fuel cell system 100 is started using a roll up generator 610. An external roll up generator can be delivered to the site on a vehicle (e.g., a truck) and electrically connected to the AC side of the fuel cell system 100 at any appropriate AC electrical node. For example, the generator 610 may be electrically connected to the start-up AC bus 603 and/or to the AC bus 403.

FIGS. 7A-7E illustrate exemplary mechanical features of the cabinets of the fuel cell system 100. The mechanical assembly can be designed to be under six feet tall, for example, to prevent the need for additional screening at residential locations in various countries. In some examples, the system 100 has a width of 1 to 2 meters, a length of 3 to 4 meters, and a height of 1.5 to 1.8 meters. The base 102 can have a height of 0.05 to 0.20 meters.

FIG. 7A illustrates lighting strips 702a-702c installed within grooves recessed in the front of the cabinets 104a-104c. For example, the lighting strips 702a-702c may be located in grooves in respective front doors 703a-703c of the cabinets 104a-104c. The lighting strips may comprise light emitting diodes (LEDs) or other suitable types of lights. These strips 702a-702c can remain illuminated continuously for enhanced aesthetics, or they can function as bar graphs indicating various levels of the system 100.

For example, the LED strip 702a on the battery cabinet 104a can display the state of charge of the battery 208, e.g., in percentage. A half-lit strip 702a would signify that 50% of the battery 208 capacity remains. In another example, the LED strip 702b on the conditioning cabinet 104b may indicate the remaining capacity of the desulfurizer beds, e.g., in percentage. In another example, the LED strip 702c on the fuel cell cabinet 104c can indicate the amount of power being produced, e.g., as a percentage of its maximum rated capacity. Alternatively, the LED strip on 702c can indicate the number of fuel cell columns that are operating at any point in time. In some examples, system 100 users may be provided an option to personalize the color or other features of each of the strips 702a-702c using, for example, a mobile app.

FIG. 7B is an exploded view of the mechanical structure for an embodiment of the fuel cell system 100. The mechanical structure can include enclosures 706, 708 made of metal, such as steel or other appropriate materials which house the fuel cell component 206 (e.g., the fuel cell columns located in the hotbox and balance of plant components), auxiliary conditioning systems (e.g., desulfurizer, water deionizer, the inverter 212, the rectifier 602, etc.), and the battery 208.

The first enclosure 706 may consist of the battery cabinet 104a having a respective door 703a. The second enclosure 708 may include the conditioning cabinet 104b and the fuel cell cabinet 104c and their respective doors 703b and 703c.

In some embodiments, the system 100 includes cosmetic panels 704a-e to enhance the visual appeal of the system. The cosmetic panels include side panels 704a and 704d, top panel 704b, rear panel 704c and front filler plates 704e located between the respective door pairs 703a and 703b, and 703b and 703c.

In embodiments, a lock or latch can be included on each door 703a, 703b, 703c to keep the doors closed. The lock or latch can secure the door tightly enough that the doors do not open while air is pulled inside through the air intakes (i.e., air inlet openings) 705 on the sides (i.e., edges) of the doors 703a, 703b, 703c. In one embodiment, the doors 703a-703c may be equipped with sensors that alert the system user and/or a remote monitoring center if the doors are not properly closed. Any suitable sensors may be used, such as magnetic contact sensors or optical sensors. Inlet air streams provided to the fuel cell columns may be filtered by placing air filters on the back sides of the doors 703a-703c next to the air intakes 705.

FIGS. 7C-7D show further details of one embodiment of the mechanical structure of the system 100. In one embodiment, the system includes two distinct enclosures: a longer one 708, referred to as Enclosure 1, and a shorter one 706, referred to as Enclosure 2. There are three doors in total, all the same size-two doors 703b and 703c are located on the longer enclosure 708, and one door 703a located is on Enclosure 2. In an alternative embodiment, both Enclosure 1 and Enclosure 2 are merged into a single enclosure with three doors.

In one embodiment, the two enclosures 706 and 708 can be shipped separately, and installed on the base 102 on-site with electrical connections established between them on-site. Alternatively, the enclosures 706, 708 and optionally the base 102 can be shipped as a single unit. Enclosure 1 is divided into three separate and airtight sections (Section 1, Section 2, and Section 3). Section 1 corresponds to the fuel cell cabinet 104c. The hotbox (HB) containing the fuel cell columns and BOP equipment is installed in Section 1. Sections 2 and 3 correspond to the sections 104b-2 and 104b-3 of the conditioning cabinet 104b. The power conditioning system (PCS) electronics (such as the fuel cell DC/DC converter, the inverter 212 and the rectifier 602) and a telemetry unit are installed in Section 2. The telemetry unit comprises communication components (e.g., wireless communication components) which permit the system 100 to communicate with a central monitoring and control facility. The fuel desulfurization unit (i.e., the desulfurizer) and water deionization unit (i.e., the deionizer) are installed in Section 3. The second enclosure 706 contains Section 4 in the battery cabinet 104a. The battery 208 and optionally the battery DC/DC converter 214 and battery cooling component (e.g., fan) may be installed in Section 4. The electrical busses 203, 210a, 210b, 603 and fluid conduits (e.g., pipes) may be installed in the base 102 with connections extending upwards into respective sections.

In one embodiment, the electronics Section 2 maintains a minimum positive air pressure of greater than 0.1 inch of water column (e.g., at least 1.05 atmospheres, such as 1.05 to 1.25 atmospheres) to ensure that any accidental gas leaks in the hotbox and desulfurization Sections 1 and 3 do not penetrate the electronics Section 2. The electronics in Section 2 include at least one fan which maintains the positive pressure. Sections 1 and 3 are equipped with fans to dilute any accidental gas leak to below the ignition level until the leak is detected and the system is transitioned to a safe (e.g., off) state. Further air separation can be created between the gas Sections 1 and 3 and the electronic Section 2 using the walls 720 located between those sections.

FIG. 7E shows additional optional aspects of the example mechanical structure. FIG. 7E shows the battery 208 in Section 4, water deionization equipment (i.e., water deionizer) 710 and fuel desulfurization equipment (i.e., desulfurizer) 712 in Section 3, power conditioning system (PCS) 715 and telemetry module in Section 2, and the fuel cell column hotbox 714, BOP components 716 and other equipment, such as ventilation fans 718, in Section 1. Walls 720 separate Section 2 form Sections 1 and 3 in the second enclosure 708.

The deionizer 710 is utilized to deionize the water inlet stream provided to the fuel cell system 100 to an acceptable level. The deionizer may comprise one or more deionizer tanks filled with any suitable deionizer material.

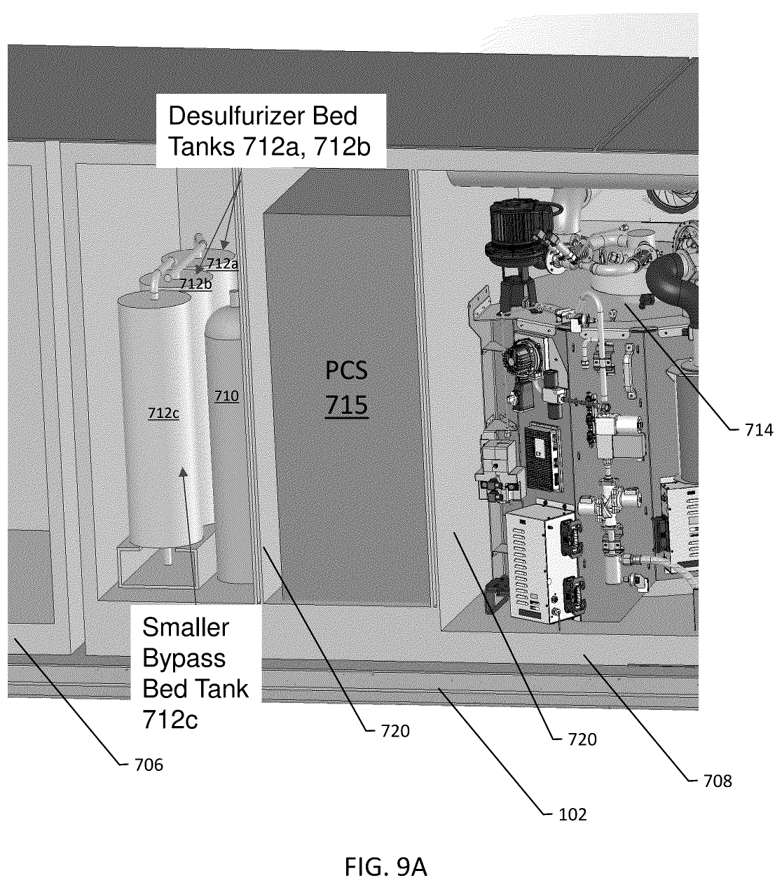

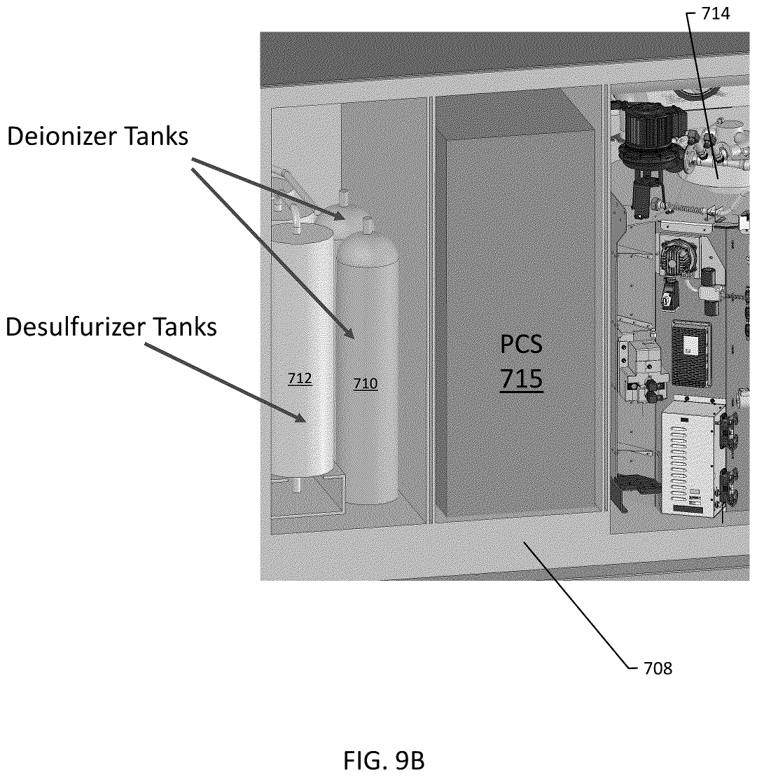

The desulfurizer 712 is configured to remove sulfur from natural gas fuel. If the incoming fuel is sulfur-free (for example, hydrogen), the desulfurizer is omitted from the fuel cell system 100. The desulfurizer 712 unit comprises plural containers (e.g., tanks) 712a-712c containing desulfurization media (e.g., sulfur adsorption and/or absorption beds). For example, there may be three containers, as shown in FIG. 9A. Typically, two containers 712a, 712b are operational and the natural gas fuel flows through these two containers in series. Should the beds in these containers sections reach capacity, i.e., get filled up, the third container 712c reserved for this purpose, is connected in series with the first two containers. A field service team can be dispatched to replenish (i.e., refill) the beds in the first two containers while the system 100 operates using the third container. Containers 712a-712c can be isolated from the fuel flow using valved bypass conduits, as described in U.S. Pat. No. 9,859,580 B2, incorporated herein by reference in its entirety.

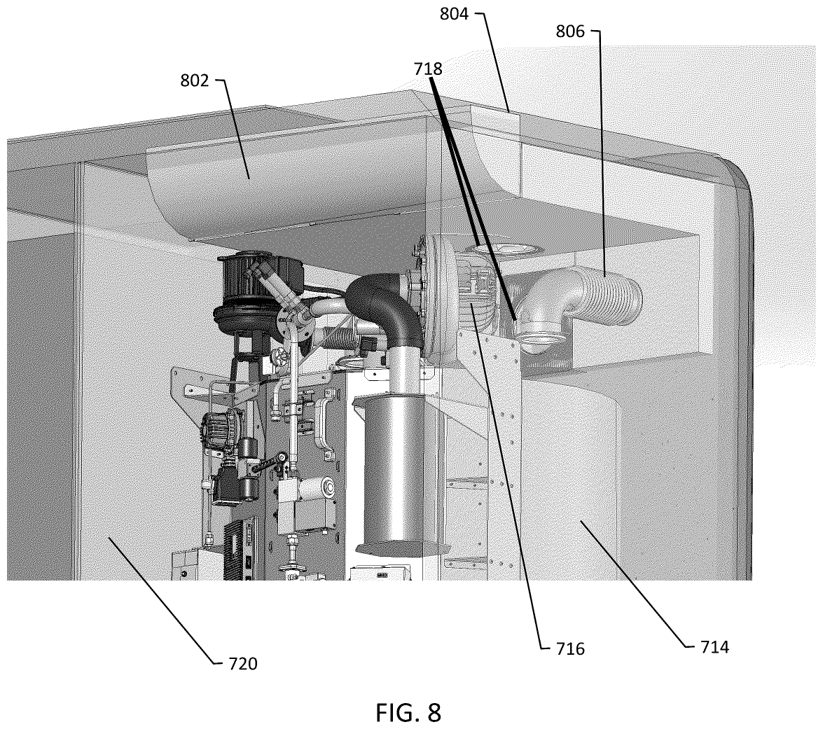

FIG. 8 shows an embodiment of the fuel cell cabinet 104c having dual cabinet ventilation fans 718. The cabinet fans 718 can pull air into the cabinet 104c through the air intake 705 on the side of the door 703c and exhaust part of the relatively cool cabinet air through an outlet manifold 802 and then through the outlet manifold exhaust port(s) 804 located on top of the cabinet 104c. The remainder of the cabinet air is provided into the hotbox 714 for use in the fuel cell columns by an air blower of the BOP components 716.

The outlet manifold 802 is also fluidly connected to the hotbox exhaust conduit 806 which fluidly connects the exhaust of the hotbox 714 to the outlet manifold 802. The exhaust of the hotbox may comprise an exhaust of the anode tailgas oxidizer (ATO) located on the hotbox 714, which oxidizes the fuel exhaust of the fuel cell columns using the air exhaust of the fuel cell columns. The relatively hot ATO exhaust is mixed with the relatively cool cabinet air in the outlet manifold 802 and exhausted through the exhaust port(s) 804 as warm combined exhaust at a temperature between 45 and 60° C.

The cabinet air flow is used for diluting any gas leaks within the cabinet to safe levels below the ignition point until the system detects the leak and initiates a shutdown. In the fuel cell system 100, the dual ventilation fans 718 not only perform this safety function but also help to dilute the exhaust from fuel cell columns in the hotbox 714, significantly reducing the temperature of the exhaust from the fuel cell system 100.

The desulfurization Section 3 may also be equipped with multiple fans for the purpose of dilution in case of accidental gas leaks. In some embodiments, the system 100 includes a non-return valve in the exhaust conduit 806 to prevent exhaust from activated fuel cell columns from flowing into deactivated fuel cell columns. Alternatively, the non-return valve may be omitted, and the exhaust from activated fuel cell columns may flow into the deactivated fuel cell columns to prevent or reduce oxidation of the nickel containing anode electrodes in of the fuel cells in the deactivated fuel cell columns.

FIGS. 9A-9B illustrate components that can be replaced live, i.e., while the fuel cell system 100 is in operation producing power, without affecting the operation of the system 100. FIG. 9A shows three containers 712a-712c of the desulfurizer 712. The desulfurization containers can be replaced live, one by one, while the fuel cell system 100 continues to produce power at its rated output. The bypass desulfurization container (i.e., bed tank) 712c may be smaller than the other two desulfurization containers (i.e., bed tanks) 712a and 712b by volume, since the bypass desulfurization container 712c is only operational when the bed in one of the other two containers 712a, 712b is spent and needs to be replaced.

FIG. 9B shows plural water deionizer containers of the water deionizer 710. The deionizer containers can be replaced live, without disrupting the system's operation, such that one of the deionizer containers can be swapped out while the other one continues to operate to deionize water and the fuel cell system 100 continues to produce power at its rated output.

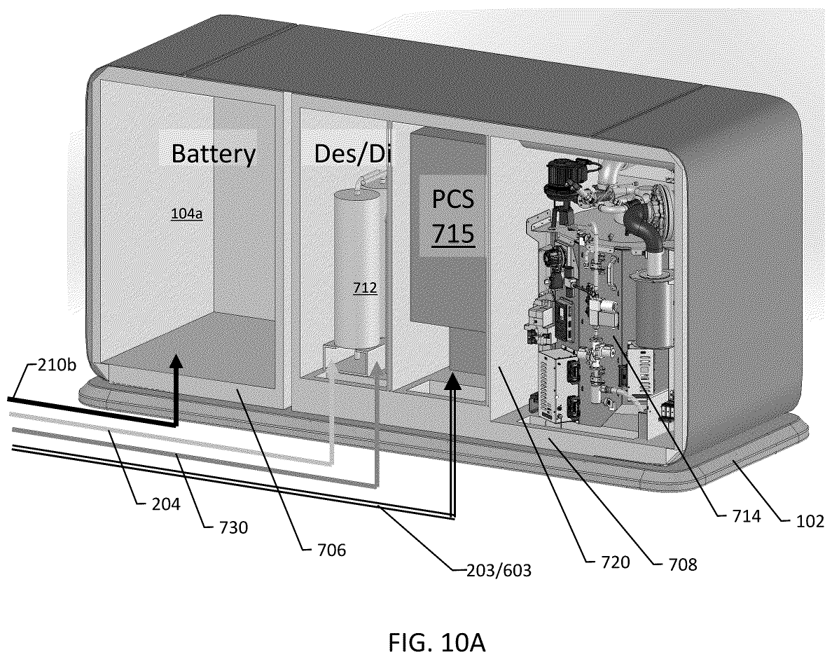

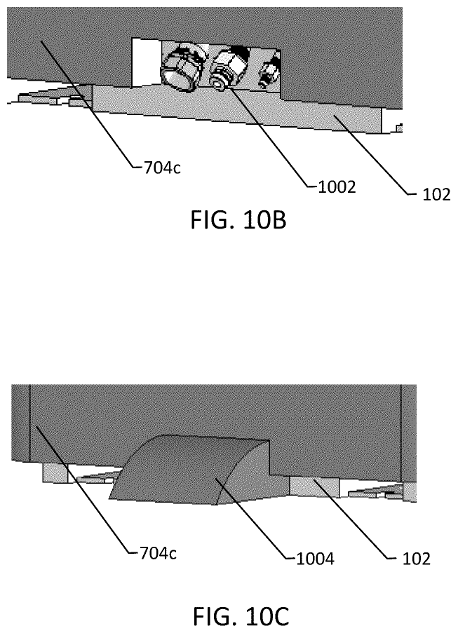

FIGS. 10A-10C illustrate electrical and fluid interconnections for the fuel cell system 100, according to various embodiments of the present disclosure.

FIG. 10A illustrates an example configuration where input/output electrical buses and fluid conduits of the fuel cell system 100 are trenched and penetrate upwards through one or more points in the base 102, e.g., in the PCS Section 2 and the desulfurization/de-ionization Section 3. The utility lines, for example, fuel conduit (e.g., the fuel source 204), water conduit 730, and optional start-up AC power line (e.g., start-up AC bus 603), along with system outputs, such as the AC output (AC bus 203) to residential load 202 and the DC output (second DC bus segment 210b) to the EV charger 216, are routed into the fuel cell system 100 from the bottom. If the base 102 is a concrete base, these utility lines can be trenched underground to ensure the best visual aesthetics, as well as to provide a tamper-proof and accident-free design on-site.

FIGS. 10B-10C show alternative electrical and fluid interconnections. The system 100 may include plug-and-play type connections 1002, with connections pre-routed to the assembly area on the ground prior to the installation of the system. During system 100 installation, these connections are quickly plugged into the fuel cell system 100, significantly reducing installation time.

FIG. 10B shows the input/output location on the system without a cover and FIG. 10C shows the input/output location on the system 100 with a cover 1004. The input/output location can be, for example, at the rear bottom, such that no pedestal or pad is required. The rear location can be useful, for example, for reduced visibility and proximity to the desulfurizer and deionizer containers.

FIGS. 11A-11E are schematic block diagrams of electrical system components of the fuel cell component 206 of the integrated fuel cell system that provide independent fuel cell column control, according to embodiments of the present disclosure.

FIG. 11A is a circuit diagram of an exemplary configuration of columns of fuel cells, C1 through C8. Each column includes one or more stacks of fuel cells, and the columns are electrically connected to an electrical ground and a corresponding fuel cell DC/DC converter. For example, the positive terminals of the columns are electrically connected to respective fuel cell DC/DC converters and negative terminals are electrically connected to ground. Thus, in one embodiment, the columns are not electrically connected to each other in pairs by an electrical jumper to form a segment which has positive and negative terminals.

Optional over current protection devices 1101, such as fuses or circuit breakers, can be coupled between the columns and the electrical ground. FIG. 11B shows an exemplary physical arrangement of the columns C1-C8 inside the hotbox 714 in top view. The columns can be arranged in a circular pattern inside the hotbox.

FIG. 11B also shows a controller 1102 configured for independent column control of the columns C1-C8. The controller 1102 can be implemented using any appropriate computing technology; for example, the controller 1102 can be implemented using one or more logic processors and memory storing instructions for the processors.

FIG. 11C is a circuit diagram of a circuit for independent column control of the fuel cell system according to an embodiment of the present disclosure. In this embodiment, each column is equipped with a separate fuel shut off valve. The fuel supply to any individual column can be isolated or connected by operating its respective fuel shutoff valve. This valve can either be a simple digital on/off valve (i.e., a shut off valve) or a proportional valve, which allows for control of amount of fuel flow to each column.

As shown in FIG. 11C the fuel cell column 1104 (e.g., any one of columns C1 to C8) is coupled to a fuel cell DC/DC converter 1106 and a fuel shutoff valve 1108. A mass flow controller (MFC) 1110 controls the flow of fuel from the desulfurizer 712 to the fuel shutoff valves 1108 of the fuel cell columns C1-C8. The fuel cell DC/DC converter 1106 provides output power to the first DC bus segment 210a, and an inverter 112 and battery DC/DC converter 114 are coupled to the first DC bus segment 210a. Depending upon the functionality of the shutoff valve 1108, the MFC may be omitted in certain embodiments.

When the fuel flow to the column 1104 is cut off by closing the valve 1108, a corresponding fuel cell DC/DC converter 1106 is also deactivated to prevent accidental current draw without fuel supply, a condition known as stack starvation. The battery 208 may serve as a buffer to smooth out the transitions during the on/off cycles of the columns.

A column 1104 is called “online” when fuel is supplied and power is drawn through a corresponding DC/DC converter 1106 or ready to be drawn. A column 1104 is called “offline” when fuel is shut off to the column and the corresponding DC/DC converter 1106 is turned off. Individual column control can be used to activate or deactivate one or more columns in response to detecting certain conditions.

In one embodiment, independent column control can be used for power management. In one example, fuel cell power may be contractually guaranteed to remain above a specified level for the customer (e.g., for the residential load). The column controller 1102 can be configured for beginning fuel cell system 100 operation with four columns and keeping the remaining four columns in standby for 2N redundancy. To ensure optimal thermal distribution, the fuel cell system starts operation with either all odd columns (C1, C3, C5 and C7) or all even columns (C2, C4, C6 and C8) at the beginning of life. Over time, the operating columns degrade, resulting in reduced output power. When the fuel cell component 206 power approaches the guaranteed limit, an additional column 1104 is brought online to increase the power output.

FIG. 11D is a power vs. time graph illustrating an exemplary scenario where individual column control is used for providing a certain level of power. In the beginning of the operational life of the fuel cell system 100, four columns (e.g., odd numbered columns C1, C3, C5, and C7) are online. When the fuel cell component 206 capacity (i.e., available fuel cell power) of those four columns drops to the guaranteed power level or below, the controller 1102 brings column C2 online. When the fuel cell component capacity of those five columns drops to the guaranteed power level or below, the controller brings column 4 online. When the fuel cell component capacity of those six columns drops to the guaranteed power level or below, the controller brings column 6 online. When the fuel cell component capacity of those seven columns drops to the guaranteed power level or below, the controller brings column 8 online. When the fuel cell component capacity of those eight columns drops to the guaranteed power level or below, the system may be at the end of its service life and a new hotbox with new columns may be installed in the system. The system controller 1102 may, upon activating the final fuel cell column, coordinate the sending of a notification signal/message to a service organization indicating that the hotbox will need to be replaced in due course. Based upon historical operations for systems in the field, it may be possible to predict the operational life remaining for the hotbox and schedule appropriate maintenance operations.

In another example, independent column control is used to compensate for column failure or dedicated column DC/DC converter failure. Dedicated DC/DC converters 1120 and 1122 are shown in FIG. 11F. In the event of a column failure, the fuel cell component power is decreased by an amount equal to the pre-fault power level of the failed column. The faulty column is taken offline by cutting off its fuel supply and disabling its fuel cell DC/DC converter, while another column is activated by allowing fuel to flow through it and turning on its DC/DC converter. The battery may provide temporary power if fuel cell power drops below residential load level.

FIG. 11E is a power vs. time graph illustrating an exemplary scenario where individual column control is used to compensate for column failure. In the beginning, four columns (1, 3, 5, and 7) are online. At some point in time, column 1 fails and is taken offline. In response, column 2 is brought online. Then, columns 2, 3, 5, and 7 are online.

In another example, independent column control can be used for extension of life/preservation of columns. If the residential load decreases below a certain threshold for an extended period (for instance, if the resident of the residence (e.g., the residential customer) goes on a vacation), the controller 1102 may take some columns offline, allowing the remaining ones to support the residential load 202. Should the residential load 202 (or the EV charger 216 load) increase, these columns are reactivated. However, reactivating columns takes time, so the battery 208 can provide power to the residential load 202 during this transition. This approach minimizes the time that columns operate at lower current levels, which is suboptimal for high-temperature fuel cell systems, such as SOFC systems.

FIG. 11F is a circuit diagram illustrating a portion of an embodiment power conditioning system including the fuel cell DC/DC converters 1106. In this embodiment, there are a total of 8 independent boost DC/DC converters 1120 (e.g., 1120a-h). Each boost DC/DC converter 1120 is connected to its respective column's C1-C8 positive and negative terminals. As described above, the negative column terminals are grounded. If the system is utilized to supply power to a vacation residence, a mobile app may be utilized to remotely bring the system up to expected residential loads so that the system is fully operational by the time the resident arrives.

The outputs of every two boost converters 1120a-h are combined and electrically connected to another isolated DC/DC converter 1120 (e.g., 1122a-d). This arrangement can be useful, for example, for optimizing power density by providing 8 independently controllable boost DC/DC converters that remain isolated from the first DC bus segment 210a. The isolated DC/DC converters 1122 are interconnected to the first DC bus segment 210a which can be, e.g., a 400V DC bus or other appropriate bus. The isolated DC/DC converters 1122a-d can provide galvanic isolation and protection from short circuits to other parts of the circuit, such as the main inverter 212.

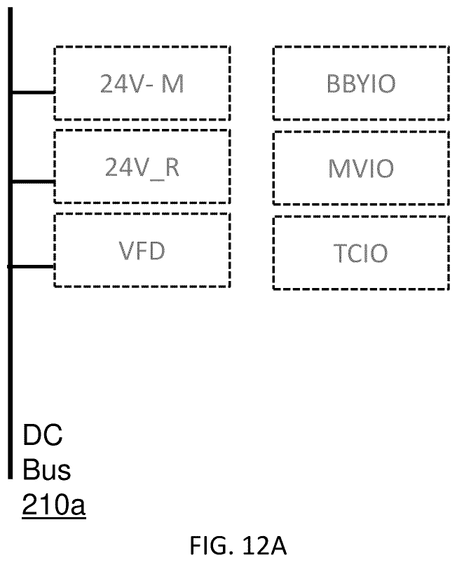

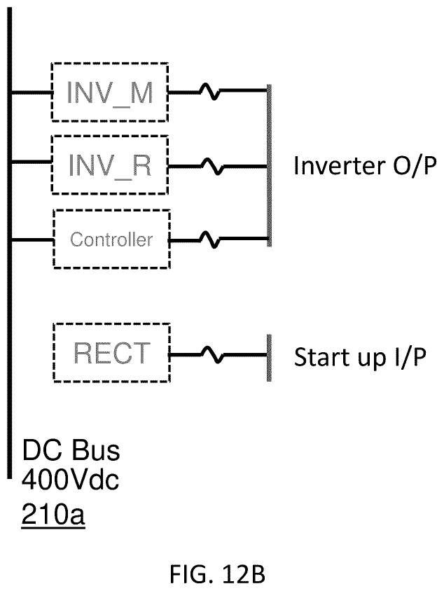

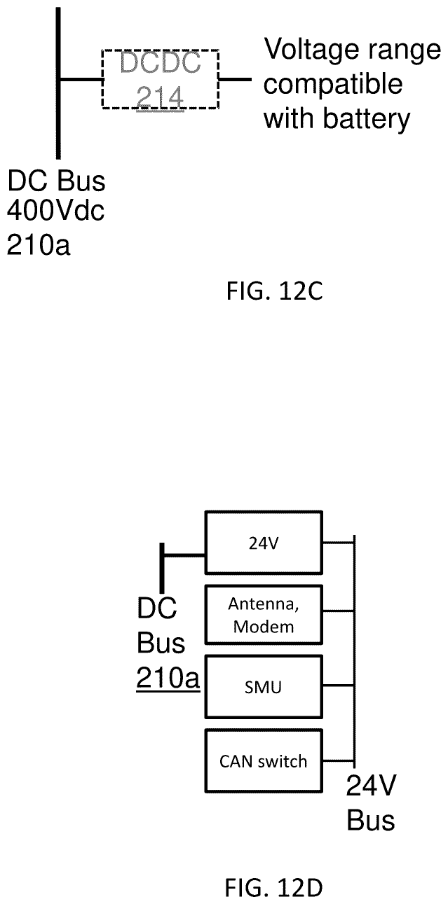

FIGS. 12A-12C illustrate other optional components of the PCS or coupled to the PCS.

FIG. 12A shows two 24V modules on the first DC bus segment 210a for redundancy. FIG. 12A also shows a variable frequency drive (VFD) that converts the DC power from the fuel cell system to AC power with a variable frequency to control the speed of motors, e.g., of fans and pumps, in the BOP of the fuel cell system 100. The VFD may also include a DC/DC master controller. FIG. 12A also shows other input/output modules (e.g., telemetry module) for internal and external communication.

FIG. 12B shows other components of an embodiment inverter 212. The inverter system comprises two inverters of equal rating: the main inverter (INV_M) and a redundant inverter (INV-R). In the event of a failure in one inverter, the other will seamlessly take over.

A controller may be integrated into the system to manage the two inverters operating in parallel. Additionally, a start-up rectifier is included, which converts AC power to DC power for the purpose of fuel cell start-up. This rectifier can either be a standard diode bridge rectifier or an Active Power Factor Correction (PFC) front-end rectifier.

FIG. 12C shows an embodiment battery DC/DC converter 214. The battery DC/DC converter 214 is located between the first DC bus segment 210a and the battery 208 and facilitates both the charging and discharging of the battery system from system DC bus. It can be configured as a single bidirectional DC/DC converter or as two separate DC/DC converters operating in opposite directions for charging and discharging purposes. The input side of the DC/DC converter functions at the system DC bus voltage, which is 400V DC in this example. The output side of the DC/DC converter is engineered to accommodate a wide range of voltages, providing the flexibility to select battery systems from multiple vendors.

FIG. 12D shows an embodiment telemetry module for the fuel cell system. The telemetry module, which can be located in the electronics section (Section 2) of Enclosure 1 or any other appropriate location, facilitates communication between the fuel cell system 100 and a Remote Monitoring and Control Center (RMCC). The RMCC can monitor the system, collect data, and remotely control operations, either autonomously or manually, via this communication channel. Information communicated to the RMCC may facilitate service operations, such as replacement of desulfurization media and deionization filters, installation of new blowers, detection of fuel leaks, and so on. The system controller may rely upon various sensors and devices (e.g., thermocouples, gas analyzers, sulfur detectors, current/voltage analyzers) placed throughout the system to monitor the health and operation of various system components described herein.

Data from all modules and subsystems within the fuel cell system can be initially gathered through the CAN bus, then converted to Ethernet using a CAN to Ethernet (C2E) Card. This data undergoes local processing for accuracy and formatting before being transmitted to the RMCC, e.g., through a secure 4G connection, utilizing a modem and antenna. It is then displayed live on HMI screens at the RMCC and/or stored in local or cloud data storage.

The ATS and EV charger information can also be integrated on to this network through an ethernet switch for a wholistic view of entire home power solutions. A house T1 connection may be substituted for the 4G connection for enhanced reliability. Alternatively, data can be routed through the RMCC by utilizing the house's Wi-Fi network, with data encrypted for cybersecurity purposes.

The fuel cell system 100 can be integrated with a mobile app and webpage, enabling customers to monitor their system and manage controls such as LED settings, load prioritization versus EV charging, and manual load transfer from the fuel cell system 100 to an alternate power source, and the like.

Additionally, the load management system can be integrated with the network and mobile app, allowing customers to optimize their power usage from the fuel cell system or to enable an optimization tool to manage autonomously on their behalf. Customers may establish specific rules for the autonomous system to adhere to. Furthermore, an artificial intelligence-based load estimation tool, which predicts future load based on historical load data analysis and available weather forecasting information, can also be incorporated into the control system.

The construction and arrangements as shown in the various examples are illustrative only. Although only a few examples have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative examples. Other substitutions, modifications, changes, and omissions may also be made in the design, operating conditions and arrangement of the various examples without departing from the scope of the present disclosure. Any one or more features of any example may be used in any combination with any one or more other features of one or more other examples. It is intended that the specification and examples be considered as exemplary only, with a true scope being indicated by the following claims and their equivalents.

What is claimed is:

1. A system, comprising:
a plurality of columns of fuel cells located in a hotbox;
a direct current (DC) bus;
a plurality of DC/DC converters, each DC/DC converter being electrically connected to a respective column of fuel cells and to the DC bus; and
a controller configured for independently controlling the columns of fuel cells, wherein the controller is configured to activate a first column of fuel cells by activating fuel flow to the first column of fuel cells and activating a first DC/DC converter of the plurality of DC/DC converters electrically connected to the first column of fuel cells while a second column of fuel cells is already active.

2. The system of claim 1, wherein the controller is further configured to deactivate one of the first or the second columns of fuel cells while the other one of the first or the second columns of fuel cells remains active by:
deactivating fuel flow to a respective one of the first or the second columns of fuel cells; and
deactivating a respective one of the first or second DC/DC converters of the plurality of DC/DC converters electrically connected to the respective one of the first or the second columns of fuel cells.

3. The system of claim 2, further comprising a plurality of fuel shutoff valves each coupled to a respective one of the plurality of columns of fuel cells,
wherein:
the activating the fuel flow to the first column of fuel cells comprises opening a first fuel shutoff valve coupled to the first column of fuel cells; and
the deactivating the fuel flow to the one of the first or the second columns of fuel cells comprises closing a respective one of the first or second fuel shutoff valves coupled to the respective one of the first or the second columns of fuel cells.

4. The system of claim 1, wherein each of the plurality of DC/DC converters is a boost converter comprising an output, and wherein the system further comprises a plurality of isolation stage DC/DC converters, wherein the outputs of every two boost converters are combined and electrically connected to an input of a respective isolation stage DC/DC converter, and wherein an output of each isolation stage DC/DC converter is electrically connected to the DC bus.

5. The system of claim 1, further comprising:
an inverter electrically connected to the DC bus and configured to provide an alternating current (AC) output to a load; and
a battery coupled to the DC bus through a battery DC/DC converter and configured to serve as a buffer during the activating first column of fuel cells activation or the deactivating the second column of fuel cells.

6. The system of claim 1, wherein:
each of the plurality of columns of fuel cells is grounded through an over current protection device; and
each of the plurality of columns of fuel cells comprises a plurality of solid oxide fuel cells separated by interconnects.

7. The system of claim 1, wherein the controller is configured to perform power management of the columns of fuel cells by:
activating, for a first period of time, a first plurality of the columns of fuel cells while keeping a second plurality of the columns of fuel cells deactivated; and
after the first period of time, detecting a reduced output power from the first plurality of the columns of fuel cells and, and in response to detecting the reduced output power, activating at least one of the second plurality of the columns of fuel cells.

8. The system of claim 1, wherein the controller is configured to compensate for column failure by:
activating a first plurality of the columns of fuel cells while keeping a second plurality of the columns of fuel cells deactivated; and
detecting a failure in at least one of the first plurality of the columns of fuel cells, and in response to detecting the failure, activating at least one of the second plurality of the columns of fuel cells.

9. The system of claim 1, wherein the controller is configured for column preservation by:
detecting that a system load has decreased below a threshold level for at least a threshold period of time;
in response to the detecting that the system load has decreased, deactivating one or more first columns of fuel cells;
detecting that the system load has increased; and
in response to detecting that the system load has increased, activating the one or more first columns of fuel cells and providing power from a battery to the system load while activating the one or more first columns of fuel cells.

10. A system comprising:
a direct current (DC) bus;
a plurality of columns of fuel cells electrically connected to the DC bus;
a battery electrically connected to the DC bus;
an inverter electrically connected to the DC bus and configured to provide an alternating current (AC) output to a load on an AC circuit; and
a start-up rectifier electrically connected to the AC circuit and to the DC bus;
wherein the start-up rectifier is configured to supply power from the AC circuit to the columns of fuel cells when starting power generation by the columns of fuel cells; and
wherein the start-up rectifier is configured to charge the battery using power from the AC circuit.

11. The system of claim 10, comprising an automatic transfer switch (ATS) comprising a first ATS input, a second ATS input, and an ATS output, wherein:
the first ATS input comprises a normal node that is electrically connected to the AC output of the inverter;
the second ATS input comprises an emergency node that is electrically connected to at least one backup power supply;
the ATS output is electrically connected to the load via the AC circuit; and
the ATS is configured to automatically detect an absence or decrease in power from the columns of fuel cells on the first ATS input and transfer the load to the backup power supply via the second ATS input.

12. The system of claim 11, wherein the backup power supply comprises at least one of a utility grid or a generator.

13. The system of claim 11, further comprising a solar power system electrically connected to the AC circuit, and wherein the solar power system is configured to charge the battery via the start-up rectifier.

14. The system of claim 11, wherein the supplying power from the AC circuit to the columns of fuel cells when starting power generation by the columns of fuel cells comprises supplying power from the backup power supply.

15. The system of claim 10, wherein the battery is configured to charge an electric vehicle when a system capacity exceeds a demand of the load.

16. The system of claim 10, further comprising a battery DC/DC converter that is electrically connected to the DC bus and to a second DC bus, wherein the battery DC/DC converter electrically connects the battery to the inverter via the DC bus and the second DC bus.

17. The system of claim 16, wherein the battery is configured to supply power via the DC bus and the second DC bus to the columns of fuel cells when starting power generation by the columns of fuel cells.

18. The system of claim 10, wherein the system is configured to charge the battery when an output power of the columns of fuel cells exceeds a load demand.

19. The system of claim 10, wherein the system is configured to smooth a load demand using compensatory power from the battery when the load demand exceeds an output power of the columns of fuel cells.

20. The system of claim 10, further comprising an electric vehicle charger, wherein the system is configured to deliver power to the electric vehicle charger based on at least one of available power from the battery, available power from the columns of fuel cells, or a load demand.

21. The system of claim 20, further comprising providing power from an electric vehicle electrically connected to the electric vehicle charger to the columns of fuel cells when starting power generation by the columns of fuel cells.

22. A system, comprising:
a first enclosure having a first section and a second section;
a fuel cell component comprising a hotbox containing a plurality of columns of fuel cells and balance of plant components installed in the first section;
a power conditioning system installed in the second section; and
a ventilation system configured for maintaining a positive air pressure in the second section.

23. The system of claim 22, further comprising a second enclosure located on a common base with the first enclosure, and a battery located in the second enclosure.

24. The system of claim 22, wherein the first enclosure further comprises a third section, and a water deionizer and a fuel desulfurizer are located in the third section, and wherein the second section is located between the first second and the second section and separated from the first second and the third section by a respective wall.

25. The system of claim 24, further comprising a first door for the first section, and a second door for the second and the third sections, wherein each of the first and second doors includes an air intake on a side of the door.

26. The system of claim 25, wherein each of the first and second doors includes a light indicator strip.

27. The system of 24, wherein the ventilation system includes at least one fan in the first section and at least one fan in the second section.

28. The system of claim 27, wherein the at least one fan in the first section comprises first and second fans in the first section that are fluidly connected to an outlet manifold.

29. The system of claim 28, further comprising an exhaust conduit which fluidly connects an exhaust of the hotbox to the outlet manifold, wherein the first and second fans are configured to dilute an exhaust from the hotbox with air in the first section.

30. The system of claim 29, further comprising a plurality of exhaust outlets on a top of the cabinet.

31. A method of operating a fuel cell system comprising a plurality of columns of fuel cells located in a hotbox, a direct current (DC) bus and a plurality of DC/DC converters, each DC/DC converter being electrically connected to a respective column of fuel cells and to the DC bus, the method comprising activating a first column of fuel cells by activating fuel flow to the first column of fuel cells and activating a first DC/DC converter of the plurality of DC/DC converters electrically connected to the first column of fuel cells while a second column of fuel cells is already active.

32. The method of claim 31, further comprising deactivating one of the first or the second columns of fuel cells while the other one of the first or the second columns of fuel cells remains active by:
deactivating fuel flow to a respective one of the first or the second columns of fuel cells; and
deactivating a respective one of the first or a second DC/DC converters of the plurality of DC/DC converters electrically connected to the respective one of the first or the second columns of fuel cells.
